(19) United States
(12) Patent Application Publication
(10) Pub. No.: US 2024/0373417 A1
(43) Pub. Date: Nov. 7, 2024

(54) TRANSMISSION WITH MULTIPLE CODEWORDS

(71) Applicant: Telefonaktiebolaget LM Ericsson (publ), Stockholm (SE)

(72) Inventors: Zhipeng Lin, Nanjing (CN); Yufei Blankenship, Kildeer, IL (US); Siva Muruganathan, Stittsville (CA); Shiwei Gao, Nepean (CA)

(21) Appl. No.: 18/683,394

(22) PCT Filed: Aug. 18, 2022
(86) PCT No.: PCT/CN2022/113256

§ 371 Date: Feb. 13, 2024

(30) Foreign Application Priority Data
Aug. 23, 2021 (WO) PCT/CN2021/114080
Sep. 3, 2021 (WO) PCT/CN2021/116545

(51) Int. Cl. H04W 72/11; H04L 1/1829; H04W 72/23

(52) U.S. Cl. CPC H04W 72/11; H04L 1/1861; H04W 72/23

(57) ABSTRACT

The present disclosure is related to a UE, a network node, and methods for uplink transmission with multiple codewords. A method at a UE for UL or DL transmission comprises: receiving, from a network node, a first message for scheduling UL or DL transmission with one or multiple codewords; and performing, with the network node, the UL or DL transmission at least partially based on the first message.

### CROSS-REFERENCE TO RELATED APPLICATION(S)

This application claims priority to the PCT International Application No. PCT/CN2021/114080, entitled “UPLINK TRANSMISSION WITH MULTIPLE CODEWORDS”, filed on Aug. 23, 2021, and the PCT International Application No. PCT/CN2021/116545, entitled “TRANSMISSION WITH MULTIPLE CODEWORDS”, filed on Sep. 3, 2021, which are incorporated herein by reference in their entireties.

### TECHNICAL FIELD

The present disclosure is related to the field of telecommunication, and in particular, to a user equipment (UE), a network node, and methods for transmission with multiple codewords.

### BACKGROUND

With the development of the electronic and telecommunications technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred—user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Transport channel is the multiplexing of the logical data to be transported by the physical layer and its channels over the radio interface.
Physical channel: The physical channels are those which are closest to the actual transmission of the data over the radio access network/5G RF signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink (UL) and downlink (DL): Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

In NR only one codeword (or one transport block) up to 4 layers can be used for PDSCH scheduled/activated by Downlink Control Information (DCI) 1_2, and only 1 Hybrid Automatic Repeat Request Acknowledgement (HARQ-ACK) bit is generated for one Semi-Persistent Scheduling (SPS) configuration in each PDSCH transmission occasion configured by the SPS configuration. When more than one codeword is used, separate configurations in SPS for the 2^{nd} or additional codeword are needed for PDSCH scheduled/activated by DCI 1_2. This also has impacts on HARQ-ACK feedback for SPS and PDCCH validation for SPS activation and deactivation. Therefore, how to address the impacts is a problem. Further, the PDCCH validation for UL Configured Grant (CG) activation and deactivation also needs to be considered when multiple codewords are supported for CG Type 2 PUSCH transmissions in uplink. Further, UE capability of support multiple codeword on SPS PDSCH transmission should be reported so that the network can schedule the transmission accordingly.

According to a first aspect of the present disclosure, a method at a UE for UL or DL transmission is provided. The method comprises: receiving, from a network node, a first message for scheduling UL or DL transmission with one or multiple codewords; and performing, with the network node, the UL or DL transmission at least partially based on the first message.

In some embodiments, the DL transmission is a first DL semi-persistent scheduling (SPS) transmission. In some embodiments, a first maximum number of the codewords that can be carried by the DL transmission is configured to the UE, wherein the first maximum number is greater than 1. In some embodiments, the first message is a Radio Resource Control (RRC) message for semi-persistently scheduling the DL transmission and indicating a first number of the codewords to be carried by the DL transmission, wherein the first number is less than or equal to the first maximum number. In some embodiments, a first number of the codewords to be carried by the DL transmission is assumed by the UE to be equal to the first maximum number. In some embodiments, when the first number is greater than 1, the method further comprises: receiving, from the network node, a second message indicating at least one of the codewords is enabled or disabled. In some embodiments, the second message is a Downlink Control information (DCI) message. In some embodiments, the second message comprises one or more fields that have one or more specific values or a specific combination of specific values, the one or more specific values or the specific combination of specific values indicating that the at least one codeword is enabled or disabled.

In some embodiments, a first number of the codewords to be carried by the DL transmission is assumed by the UE to be same as the first maximum number and no codeword is to be disabled. In some embodiments, the UE is configured with multiple DL SPS configurations comprising a first DL SPS configuration corresponding to the first DL SPS transmission, wherein whether at least one of multiple DL SPS transmissions corresponding to the multiple DL SPS configurations shall carry multiple codewords is configured independently of whether another of the multiple DL SPS transmissions shall carry multiple codewords. In some embodiments, the first DL SPS transmission is configured with multiple codewords, wherein when the first DL SPS transmission is activated by a DCI message of a first format, one or more of the multiple codewords is enabled. In some embodiments, the first DL SPS transmission is configured with multiple codewords, wherein when the first DL SPS transmission is activated by a DCI message of a second format, only one of the multiple codewords is enabled.

In some embodiments, the first format is DCI format 1_1, and the second format is DCI format 1_0 or 1_2. In some embodiments, the first DL SPS transmission is configured with multiple codewords, and the method further comprises: transmitting, to the network node, a third message comprising one or more indicators for acknowledging or negatively acknowledging at least two of the multiple codewords. In some embodiments, the step of transmitting, to the network node, the third message comprises: transmitting, to the network node, the third message comprising one or more indicators for acknowledging or negatively acknowledging the multiple codewords.

In some embodiments, the indicators are Hybrid Automatic Repeat Request-Acknowledgement (HARQ-ACK) bits. In some embodiments, at least one indicator is a bundled indicator that acknowledges or negatively acknowledges two or more codewords. In some embodiments, a bundled indicator acknowledges or negatively acknowledges two or more codewords by performing a logical AND operation on HARQ-ACK bits for the two or more codewords when a HARQ-ACK bit of 1 indicates a successfully decoded codeword while a HARQ-ACK bit of 0 indicates an unsuccessfully decoded codeword. In some embodiments, the method further comprises: receiving, from the network node, a configuration indicating whether the indicators in the third message shall be bundled indicators or not. In some embodiments, the configuration is a first information element (IE) when the third message is a PUSCH message, wherein the configuration is a second IE that is different from the first IE when the third message is a PUCCH message. In some embodiments, the first IE is SPS-harq-ACK-SpatialBundlingPUSCH, and the second IE is SPS-harq-ACK-SpatialBundlingPUCCH.

In some embodiments, the DL transmission is a first DL transmission. In some embodiments, the first DL transmission is scheduled, activated, or released by a DCI message that has a different format than DCI format 1_1 and supports the multiple codewords. In some embodiments, the DCI message is a DCI format 1_2 message or a DCI message of a format other than DCI formats 1_0, 1_1, and 1_2. In some embodiments, a second maximum number of the codewords that can be scheduled by the DCI message is configured to the UE. In some embodiments, the second maximum number is configured by a maxNrofCodeWordsScheduledByDCI-1-2 IE in a PDSCH-Config IE that is configured to the UE by the network node. In some embodiments, at least one of the following fields is configured to the UE for each of at least two of the multiple codewords: —Modulation and Coding Scheme (MCS); —New Indicator (NDI); and —Redundancy Version (RV).

In some embodiments, the DL or UL transmission is a first DL SPS transmission or a first UL Type-2 Configured Grant (CG) transmission, respectively. In some embodiments, the method further comprises: receiving, from the network node, a fourth message; and validating the fourth message for scheduling activation or scheduling release. In some embodiments, the fourth message is a DCI message. In some embodiments, the step of validating the fourth message comprises: checking whether at least one field of the fourth message is set according to a predefined criterion or not. In some embodiments, the at least one field comprises at least one of: —HARQ process number; —one or more RVs for one or more codewords; —one or more MCSs for one or more codewords; and —a frequency domain resource assignment (FDRA) type.

In some embodiments, when a single DL SPS is configured to the UE and when the DL transmission is the DL SPS transmission corresponding to the single DL SPS, the fourth message is validated for scheduling activation when at least one field of the fourth message is set as at least one of: —HARQ process number field is set to all ‘0’s when the DCI message is a DCI format 1_0 message; —HARQ process number field is set to all ‘0’s when the DCI message is a DCI format 1_1 message; —HARQ process number field is set to all ‘0’s when the DCI message is a DCI format 1_2 message; —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; and —RV field for a second TB is set to all ‘0’s when the DCI message is a DCI format 1_2 message. For example, at least one field of the fourth message is set as follows:

| | DCI format 1_0 | DCI format 1_1/1_2 |
|---|---|---|
| HARQ process number | set to all ‘0’s | set to all ‘0’s |
| Redundancy version | set to all ‘0’s | set to all ‘0’s |
| for first TB | | |
| Redundancy version | N/A | set to all ‘0’s |
| for second TB | | |

In some embodiments, when a single UL Type-2 CG is configured to the UE and when the UL transmission is the UL Type-2 CG transmission corresponding to the single UL Type-2 CG, the fourth message is validated for scheduling activation when at least one field of the fourth message is set as at least one of: —HARQ process number field is set to all ‘0’s when the DCI message is a DCI format 0_0 message; —HARQ process number field is set to all ‘0’s when the DCI message is a DCI format 0_1 message; —HARQ process number field is set to all ‘0’s when the DCI message is a DCI format 0_2 message; —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; and —RV field for a second TB is set to all ‘0’s when the DCI message is a DCI format 0_2 message. For example, at least one field of the fourth message is set as follows:

| | DCI format 0_0 | DCI format 0_1/0_2 |
|---|---|---|
| HARQ process number | set to all ‘0’s | set to all ‘0’s |
| Redundancy version | set to all ‘0’s | set to all ‘0’s |
| for first TB | | |
| Redundancy version | N/A | set to all ‘0’s |
| for second TB | | |

In some embodiments, when a single DL SPS is configured to the UE and when the DL transmission is the DL SPS transmission corresponding to the single DL SPS, the fourth message is validated for scheduling release when at least one field of the fourth message is set as at least one of: —HARQ process number field is set to all ‘0’s when the DCI message is a DCI format 1_0 message; —HARQ process number field is set to all ‘0’s when the DCI message is a DCI format 1_1 message; —HARQ process number field is set to all ‘0’s when the DCI message is a DCI format 1_2 message; —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; —RV field for a second TB is set to all ‘0’s when the DCI message is a DCI format 1_2 message; —MCS field for a first TB is set to all ‘1’s when the DCI message is a DCI format 1_0 message; —MCS field for a first TB is set to all ‘1’s when the DCI message is a DCI format 1_1 message; —MCS field for a first TB is set to all ‘1’s when the DCI message is a DCI format 1_2 message; —MCS field for a second TB is set to all ‘1’s when the DCI message is a DCI format 1_1 message; —MCS field for a second TB is set to all ‘1’s when the DCI message is a DCI format 1_2 message; —FDRA field is set to all ‘0’s for FDRA Type 0 or for dynamicSwitch and/or set to all ‘1’s for FDRA Type 1 when the DCI message is a DCI format 1_0 message; —FDRA field is set to all ‘0’s for FDRA Type 0 or for dynamicSwitch and/or set to all ‘1’s for FDRA Type 1 when the DCI message is a DCI format 1_1 message; and —FDRA field is set to all ‘0’s for FDRA Type 0 or for dynamicSwitch and/or set to all ‘1’s for FDRA Type 1 when the DCI message is a DCI format 1_2 message. For example, at least one field of the fourth message is set as follows:

| | DCI format 1_0 | DCI format 1_1/1_2 |
|---|---|---|
| HARQ process number | set to all ‘0’s | set to all ‘0’s |
| Redundancy version for first TB | set to all ‘0’s | set to all ‘0’s |
| Redundancy version for second | N/A | set to all ‘0’s |
| TB | | |
| Modulation and coding scheme | set to all ‘1’s | set to all ‘1’s |
| for first TB | | |
| Modulation and coding scheme | N/A | set to all ‘1’s |
| for second TB | | |
| Frequency domain resource | set to all ‘0’s for | set to all ‘0’s for |
| assignment | FDRA Type 0 or for dynamicSwitch | FDRA Type 0 or for dynamicSwitch |
| | set to all ‘1’s for FDRA Type 1 | set to all ‘1’s for FDRA Type 1 |

In some embodiments, when a single UL Type-2 CG is configured to the UE and when the UL transmission is the UL Type-2 CG transmission corresponding to the single UL Type-2 CG, the fourth message is validated for scheduling release when at least one field of the fourth message is set as at least one of: —HARQ process number field is set to all ‘0’s when the DCI message is a DCI format 0_0 message; —HARQ process number field is set to all ‘0’s when the DCI message is a DCI format 0_1 message; —HARQ process number field is set to all ‘0’s when the DCI message is a DCI format 0_2 message; —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; —RV field for a second TB is set to all ‘0’s when the DCI message is a DCI format 0_2 message; —MCS field for a first TB is set to all ‘1’s when the DCI message is a DCI format 0_0 message; —MCS field for a first TB is set to all ‘1’s when the DCI message is a DCI format 0_1 message; —MCS field for a first TB is set to all ‘1’s when the DCI message is a DCI format 0_2 message; —MCS field for a second TB is set to all ‘1’s when the DCI message is a DCI format 0_1 message; —MCS field for a second TB is set to all ‘1’s when the DCI message is a DCI format 0_2 message; —FDRA field is set to all ‘0’s for FDRA Type 2 with μ=1 and/or set to all ‘1’s otherwise, when the DCI message is a DCI format 0_0 message; —FDRA field is set to all ‘0’s for FDRA Type 2 with μ=1 and/or set to all ‘1’s otherwise, when the DCI message is a DCI format 0_1 message; and —FDRA field is set to all ‘0’s for FDRA Type 2 with μ=1 and/or set to all ‘1’s otherwise, when the DCI message is a DCI format 0_2 message. For example, at least one field of the fourth message is set as follows:

| | DCI format 0_0 | DCI format 0_1/0_2 |
|---|---|---|
| HARQ process number | set to all ‘0’s | set to all ‘0’s |
| Redundancy version for first TB | set to all ‘0’s | set to all ‘0’s |
| Redundancy version for second TB | N/A | set to all ‘0’s |
| Modulation and coding scheme for | set to all ‘1’s | set to all ‘1’s |
| first TB | | |
| Modulation and coding scheme for | N/A | set to all ‘1’s |
| second TB | | |
| Frequency domain resource | set to all ‘0’s for | set to all ‘0’s for |
| assignment | FDRA Type 2 with μ = 1 | FDRA Type 2 with μ = 1 |
| | set to all ‘1’s, otherwise | set to all ‘1’s, otherwise |

In some embodiments, when multiple DL SPSs are configured to the UE and when the DL transmission is one of multiple DL SPS transmissions corresponding to the multiple DL SPSs, and when a HARQ process number field in the fourth message has a same value as that of an sps-ConfigIndex IE configured for the first DL SPS transmission, the fourth message is validated for scheduling activation when at least one field of the fourth message is set as at least one of: —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; and —RV field for a second TB is set to all ‘0’s when the DCI message is a DCI format 1_2 message. For example, at least one field of the fourth message is set as follows:

| | DCI format 1_0 | DCI format 1_1/1_2 |
|---|---|---|
| Redundancy version | set to all ‘0’s | set to all ‘0’s |
| for first TB | | |
| Redundancy version | N/A | set to all ‘0’s |
| for second TB | | |

In some embodiments, when multiple UL Type-2 CGs are configured to the UE and when the UL transmission is one of multiple UL Type-2 CG transmissions corresponding to the multiple UL Type-2 CGs, and when a HARQ process number field in the fourth message has a same value as that of a ConfiguredGrantConfigIndex IE configured for the first UL Type-2 CG transmission, the fourth message is validated for scheduling activation when at least one field of the fourth message is set as at least one of: —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; and —RV field for a second TB is set to all ‘0’s when the DCI message is a DCI format 0_2 message. For example, at least one field of the fourth message is set as follows:

| | DCI format 0_0 | DCI format 0_1/0_2 |
|---|---|---|
| Redundancy version | set to all ‘0’s | set to all ‘0’s |
| for first TB | | |
| Redundancy version | N/A | set to all ‘0’s |
| for second TB | | |

In some embodiments, when multiple DL SPSs are configured to the UE and when the DL transmission is one of multiple DL SPS transmissions corresponding to the multiple DL SPSs, when a HARQ process number field in the fourth message has a same value as that of an sps-ConfigIndex IE configured for the first DL SPS transmission, the fourth message is validated for scheduling release when at least one field of the fourth message is set as at least one of: —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; —RV field for a second TB is set to all ‘0’s when the DCI message is a DCI format 1_2 message; —MCS field is set to all ‘1’s when the DCI message is a DCI format 1_0 message; —MCS field is set to all ‘1’s when the DCI message is a DCI format 1_1 message; —MCS field is set to all ‘1’s when the DCI message is a DCI format 1_2 message; —FDRA field is set to all ‘0’s for FDRA Type 0 or for dynamicSwitch and/or set to all ‘1’s for FDRA Type 1 when the DCI message is a DCI format 1_0 message; —FDRA field is set to all ‘0’s for FDRA Type 0 or for dynamicSwitch and/or set to all ‘1’s for FDRA Type 1 when the DCI message is a DCI format 1_1 message; and —FDRA field is set to all ‘0’s for FDRA Type 0 or for dynamicSwitch and/or set to all ‘1’s for FDRA Type 1 when the DCI message is a DCI format 1_2 message. For example, at least one field of the fourth message is set as follows:

| | DCI format 1_0 | DCI format 1_1/1_2 |
|---|---|---|
| Redundancy version for first | set to all ‘0’s | set to all ‘0’s |
| TB | | |
| Redundancy version for | N/A | set to all ‘0’s |
| second TB | | |
| Modulation and coding | set to all ‘1’s | set to all ‘1’s |
| scheme | | |
| Frequency domain resource | set to all ‘0’s for FDRA | set to all ‘0’s for FDRA |
| assignment | Type 0 or for dynamicSwitch | Type 0 or for dynamicSwitch |
| | set to all ‘1’s for FDRA Type 1 | set to all ‘1’s for FDRA Type 1 |

In some embodiments, when multiple UL Type-2 CGs are configured to the UE and when the UL transmission is one of multiple UL Type-2 CG transmissions corresponding to the multiple UL Type-2 CGs, when a HARQ process number field in the fourth message has a same value as that of a ConfiguredGrantConfigIndex IE configured for the first UL Type-2 CG transmission, the fourth message is validated for scheduling release when at least one field of the fourth message is set as at least one of: —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; —RV field for a second TB is set to all ‘0’s when the DCI message is a DCI format 0_2 message; —MCS field is set to all ‘1’s when the DCI message is a DCI format 0_0 message; —MCS field is set to all ‘1’s when the DCI message is a DCI format 0_1 message; —MCS field is set to all ‘1’s when the DCI message is a DCI format 0_2 message; —FDRA field is set to all ‘0’s for FDRA Type 2 with μ=1 and/or set to all ‘1’s otherwise, when the DCI message is a DCI format 0_0 message; —FDRA field is set to all ‘0’s for FDRA Type 2 with μ=1 and/or set to all ‘1’s otherwise, when the DCI message is a DCI format 0_1 message; and —FDRA field is set to all ‘0’s for FDRA Type 2 with μ=1 and/or set to all ‘1’s otherwise, when the DCI message is a DCI format 0_2 message. For example, at least one field of the fourth message is set as follows:

| | DCI format 0_0 | DCI format 0_1/0_2 |
|---|---|---|
| Redundancy version for first TB | set to all ‘0’s | set to all ‘0’s |
| Redundancy version for second TB | N/A | set to all ‘0’s |
| Modulation and coding scheme | set to all ‘1’s | set to all ‘1’s |
| Frequency domain resource | set to all ‘0’s for | set to all ‘0’s for |
| assignment | FDRA Type 2 with μ = 1 | FDRA Type 2 with μ = 1 |
| | set to all ‘1’s, otherwise | set to all ‘1’s, otherwise |

In some embodiments, the method further comprises: transmitting, to the network node, a fifth message indicating whether DL transmission with multiple codewords and/or with more than 4 layers is supported by the UE or not. In some embodiments, the fifth message indicates at least one of: —whether DL SPS transmission with multiple codewords and/or with more than 4 layers is supported by the UE or not; and —whether dynamic grant (DG) based DL transmission with multiple codewords and/or with more than 4 layers is supported by the UE or not. In some embodiments, whether DL SPS transmission with multiple codewords and/or with more than 4 layers is supported by the UE or not is indicated by a third IE, wherein whether DG based DL transmission with multiple codewords and/or with more than 4 layers is supported by the UE or not is indicated by a fourth IE that is different from the third IE.

In some embodiments, the fifth message is transmitted when the UE is in the connected state. In some embodiments, the fifth message further indicates whether the DL transmission with multiple codewords and/or with more than 4 layers can be scheduled by a DCI message of a specific format. In some embodiments, the specific format is DCI format 1_2 or another DCI format than DCI formats 1_0, 1_1, and 1_2.

In some embodiments, the UL or DL transmission is PDSCH transmission or PUSCH transmission. In some embodiments, the network node comprises a TRP.

According to a second aspect of the present disclosure, a UE is provided. The UE comprises: a processor; a memory storing instructions which, when executed by the processor, cause the processor to perform the method of any of the first aspect.

According to a third aspect of the present disclosure, a UE is provided. The UE comprises: a receiving module for receiving, from a network node, a first message for scheduling UL or DL transmission with one or multiple codewords; and a performing module for performing, with the network node, the UL or DL transmission at least partially based on the first message.

According to a fourth aspect of the present disclosure, a method at a network node for UL or DL transmission is provided. The method comprises: transmitting, to a UE, a first message for scheduling UL or DL transmission with one or multiple codewords; and performing, with the UE, the UL or DL transmission at least partially based on the first message.

In some embodiments, the DL transmission is a first DL SPS transmission. In some embodiments, a first maximum number of the codewords that can be carried by the DL transmission is configured to the UE, wherein the first maximum number is greater than 1. In some embodiments, the first message is an RRC message for semi-persistently scheduling the DL transmission and indicating a first number of the codewords to be carried by the DL transmission, wherein the first number is less than or equal to the first maximum number. In some embodiments, a first number of the codewords to be carried by the DL transmission is assumed by the network node to be equal to the first maximum number. In some embodiments, when the first number is greater than 1, the method further comprises: transmitting, to the UE, a second message indicating at least one of the codewords is enabled or disabled. In some embodiments, the second message is a DCI message. In some embodiments, the second message comprises one or more fields that have one or more specific values or a specific combination of specific values, the one or more specific values or the specific combination of specific values indicating that the at least one codeword is enabled or disabled.

In some embodiments, a first number of the codewords to be carried by the DL transmission is assumed by the network to be same as the first maximum number and no codeword is to be disabled. In some embodiments, the UE is configured by the network node with multiple DL SPS configurations comprising a first DL SPS configuration corresponding to the first DL SPS transmission, wherein whether at least one of multiple DL SPS transmissions corresponding to the multiple DL SPS configurations shall carry multiple codewords is configured independently of whether another of the multiple DL SPS transmissions shall carry multiple codewords.

In some embodiments, the first DL SPS transmission is configured with multiple codewords, wherein when the first DL SPS transmission is activated by a DCI message of a first format, one or more of the multiple codewords is enabled. In some embodiments, the first DL SPS transmission is configured with multiple codewords, wherein when the first DL SPS transmission is activated by a DCI message of a second format, only one of the multiple codewords is enabled. In some embodiments, the first format is DCI format 1_1, and the second format is DCI format 1_0 or 1_2. In some embodiments, the first DL SPS transmission is configured with multiple codewords, and the method further comprises: receiving, from the UE, a third message comprising one or more indicators for acknowledging or negatively acknowledging at least two of the multiple codewords. In some embodiments, the step of receiving, from the UE, the third message comprises: receiving, from the UE, the third message comprising one or more indicators for acknowledging or negatively acknowledging the multiple codewords.

In some embodiments, the indicators are HARQ-ACK bits. In some embodiments, at least one indicator is a bundled indicator that acknowledges or negatively acknowledges two or more codewords. In some embodiments, a bundled indicator acknowledges or negatively acknowledges two or more codewords by performing a logical AND operation on HARQ-ACK bits for the two or more codewords when a HARQ-ACK bit of 1 indicates a successfully decoded codeword while a HARQ-ACK bit of 0 indicates an unsuccessfully decoded codeword. In some embodiments, the method further comprises: transmitting, to the UE, a configuration indicating whether the indicators in the third message shall be bundled indicators or not. In some embodiments, the configuration is a first IE when the third message is a PUSCH message, wherein the configuration is a second IE that is different from the first IE when the third message is a PUCCH message. In some embodiments, the first IE is SPS-harq-ACK-SpatialBundlingPUSCH, and the second IE is SPS-harq-ACK-SpatialBundlingPUCCH. In some embodiments, the DL transmission is a first DL transmission. In some embodiments, the first DL transmission is scheduled, activated, or released by a DCI message that has a different format than DCI format 1_1 and supports the multiple codewords. In some embodiments, the DCI message is a DCI format 1_2 message or a DCI message of a format other than DCI formats 1_0, 1_1, and 1_2.

In some embodiments, a second maximum number of the codewords that can be scheduled by the DCI message is configured to the UE by the network node. In some embodiments, the second maximum number is configured by a maxNrofCodeWordsScheduledByDCI-1-2 IE in a PDSCH-Config IE that is configured to the UE by the network node. In some embodiments, at least one of the following fields is configured to the UE by the network node for each of at least two of the multiple codewords: —MCS; —NDI; and —RV. In some embodiments, the DL or UL transmission is a first DL SPS transmission or a first UL Type-2 CG transmission, respectively. In some embodiments, the method further comprises: generating a fourth message for activating or releasing the transmission; and transmitting, to the UE, the fourth message. In some embodiments, the fourth message is a DCI message. In some embodiments, the step of generating the fourth message comprises: setting at least one field of the fourth message according to a predefined criterion associated with scheduling activation or scheduling release. In some embodiments, the at least one field comprises at least one of: —HARQ process number; —one or more RVs for one or more codewords; —one or more MCSs for one or more codewords; and —an FDRA type.

In some embodiments, when a single DL SPS is configured to the UE and when the DL transmission is the DL SPS transmission corresponding to the single DL SPS, and when the fourth message is generated for scheduling activation, the at least one field of the fourth message is set as at least one of: —HARQ process number field is set to all ‘0’s when the DCI message is a DCI format 1_0 message; —HARQ process number field is set to all ‘0’s when the DCI message is a DCI format 1_1 message; —HARQ process number field is set to all ‘0’s when the DCI message is a DCI format 1_2 message; —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; and —RV field for a second TB is set to all ‘0’s when the DCI message is a DCI format 1_2 message. For example, at least one field of the fourth message is set as follows:

| | DCI format 1_0 | DCI format 1_1/1_2 |
|---|---|---|
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |

In some embodiments, when a single UL Type-2 CG is configured to the UE and when the UL transmission is the UL Type-2 CG transmission corresponding to the single UL Type-2 CG, and when the fourth message is generated for scheduling activation, the at least one field of the fourth message is set as at least one of: —HARQ process number field is set to all ‘0’s when the DCI message is a DCI format 0_0 message; —HARQ process number field is set to all ‘0’s when the DCI message is a DCI format 0_1 message; —HARQ process number field is set to all ‘0’s when the DCI message is a DCI format 0_2 message; —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; and —RV field for a second TB is set to all ‘0’s when the DCI message is a DCI format 0_2 message. For example, at least one field of the fourth message is set as follows:

| | DCI format 0_0 | DCI format 0_1/0_2 |
|---|---|---|
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |

In some embodiments, when a single DL SPS is configured to the UE and when the DL transmission is the DL SPS transmission corresponding to the single DL SPS, and when the fourth message is generated for scheduling release, the at least one field of the fourth message is set as at least one of: —HARQ process number field is set to all ‘0’s when the DCI message is a DCI format 1_0 message; —HARQ process number field is set to all ‘0’s when the DCI message is a DCI format 1_1 message; —HARQ process number field is set to all ‘0’s when the DCI message is a DCI format 1_2 message; —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; —RV field for a second TB is set to all ‘0’s when the DCI message is a DCI format 1_2 message; —MCS field for a first TB is set to all ‘1’s when the DCI message is a DCI format 1_0 message; —MCS field for a first TB is set to all ‘1’s when the DCI message is a DCI format 1_1 message; —MCS field for a first TB is set to all ‘1’s when the DCI message is a DCI format 1_2 message; —MCS field for a second TB is set to all ‘1’s when the DCI message is a DCI format 1_1 message; —MCS field for a second TB is set to all ‘1’s when the DCI message is a DCI format 1_2 message; —FDRA field is set to all ‘0’s for FDRA Type 0 or for dynamicSwitch and/or set to all ‘1’s for FDRA Type 1 when the DCI message is a DCI format 1_0 message; —FDRA field is set to all ‘0’s for FDRA Type 0 or for dynamicSwitch and/or set to all ‘1’s for FDRA Type 1 when the DCI message is a DCI format 1_1 message; and —FDRA field is set to all ‘0’s for FDRA Type 0 or for dynamicSwitch and/or set to all ‘1’s for FDRA Type 1 when the DCI message is a DCI format 1_2 message. For example, at least one field of the fourth message is set as follows:

| | DCI format | DCI format |
|---|---|---|
| | 1_0 | 1_1/1_2 |
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |
| Modulation and coding | set to all ‘1’s | set to all ‘1’s |
| scheme for first TB | | |
| Modulation and coding | N/A | set to all ‘1’s |
| scheme for second TB | | |
| Frequency domain resource | set to all ‘0’s for | set to all ‘0’s for |
| assignment | FDRA Type 0 or for | FDRA Type 0 or for |
| | dynamicSwitch | dynamicSwitch |
| | set to all ‘1’s for | set to all ‘1’s for |
| | FDRA Type 1 | FDRA Type 1 |

In some embodiments, when a single UL Type-2 CG is configured to the UE and when the UL transmission is the UL Type-2 CG transmission corresponding to the single UL Type-2 CG, and when the fourth message is generated for scheduling release, the at least one field of the fourth message is set as at least one of: —HARQ process number field is set to all ‘0’s when the DCI message is a DCI format 0_0 message; —HARQ process number field is set to all ‘0’s when the DCI message is a DCI format 0_1 message; —HARQ process number field is set to all ‘0’s when the DCI message is a DCI format 0_2 message; —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; —RV field for a second TB is set to all ‘0’s when the DCI message is a DCI format 0_2 message; —MCS field for a first TB is set to all ‘1’s when the DCI message is a DCI format 0_0 message; —MCS field for a first TB is set to all ‘1’s when the DCI message is a DCI format 0_1 message; —MCS field for a first TB is set to all ‘1’s when the DCI message is a DCI format 0_2 message; —MCS field for a second TB is set to all ‘1’s when the DCI message is a DCI format 0_1 message; —MCS field for a second TB is set to all ‘1’s when the DCI message is a DCI format 0_2 message; —FDRA field is set to all ‘0’s for FDRA Type 2 with μ=1 and/or set to all ‘1’s otherwise, when the DCI message is a DCI format 0_0 message; —FDRA field is set to all ‘0’s for FDRA Type 2 with μ=1 and/or set to all ‘1’s otherwise, when the DCI message is a DCI format 0_1 message; and —FDRA field is set to all ‘0’s for FDRA Type 2 with μ=1 and/or set to all ‘1’s otherwise, when the DCI message is a DCI format 0_2 message. For example, at least one field of the fourth message is set as follows:

| | DCI format | DCI format |
|---|---|---|
| | 0_0 | 0_1/0_2 |
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |
| Modulation and coding scheme | set to all ‘1’s | set to all ‘1’s |
| for first TB | | |
| Modulation and coding scheme | N/A | set to all ‘1’s |
| for second TB | | |
| Frequency domain resource | set to all ‘0’s for | set to all ‘0’s for |
| assignment | FDRA Type 2 | FDRA Type 2 |
| | with μ = 1 | with μ = 1 |
| | set to all ‘1’s, | set to all ‘1’s, |
| | otherwise | otherwise |

In some embodiments, when multiple DL SPSs are configured to the UE and when the DL transmission is one of multiple DL SPS transmissions corresponding to the multiple DL SPSs, and when the fourth message is generated for scheduling activation, a HARQ process number field in the fourth message is set as a value of an sps-ConfigIndex IE configured for the first DL SPS transmission and the at least one field of the fourth message is set as at least one of: —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; and —RV field for a second TB is set to all ‘0’s when the DCI message is a DCI format 1_2 message. For example, at least one field of the fourth message is set as follows:

| | DCI format 1_0 | DCI format 1_1/1_2 |
|---|---|---|
| Redundancy version for | set to all ‘0’s | set to all ‘0’s |
| first TB | | |
| Redundancy version for | N/A | set to all ‘0’s |
| second TB | | |

In some embodiments, when multiple UL Type-2 CGs are configured to the UE and when the UL transmission is one of multiple UL Type-2 CG transmissions corresponding to the multiple UL Type-2 CGs, and when the fourth message is generated for scheduling activation, a HARQ process number field in the fourth message is set as a value of a ConfiguredGrantConfigIndex IE configured for the first UL Type-2 CG transmission, and the at least one field of the fourth message is set as at least one of: —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; and —RV field for a second TB is set to all ‘0’s when the DCI message is a DCI format 0_2 message. For example, at least one field of the fourth message is set as follows:

| | DCI format 0_0 | DCI format 0_1/0_2 |
|---|---|---|
| Redundancy version for | set to all ‘0’s | set to all ‘0’s |
| first TB | | |
| Redundancy version for | N/A | set to all ‘0’s |
| second TB | | |

In some embodiments, when multiple DL SPSs are configured to the UE and when the DL transmission is one of multiple DL SPS transmissions corresponding to the multiple DL SPSs, and when the fourth message is generated for scheduling release, a HARQ process number field in the fourth message is set as a value of an sps-ConfigIndex IE configured for the first DL SPS transmission, and the at least one field of the fourth message is set as at least one of: —RV field for a first TB is set to all ‘0’s when the DCI message is a DCI format 1_0 message; —RV field for a first TB is set to all ‘0’s when the DCI message is a DCI format 1_1 message; —RV field for a first TB is set to all ‘0’s when the DCI message is a DCI format 1_2 message; —RV field for a second TB is set to all ‘0’s when the DCI message is a DCI format 1_1 message; —RV field for a second TB is set to all ‘0’s when the DCI message is a DCI format 1_2 message; —MCS field is set to all ‘1’s when the DCI message is a DCI format 1_0 message; —MCS field is set to all ‘1’s when the DCI message is a DCI format 1_1 message; —MCS field is set to all ‘1’s when the DCI message is a DCI format 1_2 message; —FDRA field is set to all ‘0’s for FDRA Type 0 or for dynamicSwitch and/or set to all ‘1’s for FDRA Type 1 when the DCI message is a DCI format 1_0 message; —FDRA field is set to all ‘0’s for FDRA Type 0 or for dynamicSwitch and/or set to all ‘1’s for FDRA Type 1 when the DCI message is a DCI format 1_1 message; and —FDRA field is set to all ‘0’s for FDRA Type 0 or for dynamicSwitch and/or set to all ‘1’s for FDRA Type 1 when the DCI message is a DCI format 1_2 message. For example, at least one field of the fourth message is set as follows:

| | DCI format 1_0 | DCI format 1_1/1_2 |
|---|---|---|
| Redundancy version for | set to all ‘0’s | set to all ‘0’s |
| first TB | | |
| Redundancy version for | N/A | set to all ‘0’s |
| second TB | | |
| Modulation and coding | set to all ‘1’s | set to all ‘1’s |
| scheme | | |
| Frequency domain resource | set to all ‘0’s for | set to all ‘0’s for |
| assignment | FDRA Type 0 or for | FDRA Type 0 or for |
| | dynamicSwitch | dynamicSwitch |
| | set to all ‘1’s for | set to all ‘1’s for |
| | FDRA Type 1 | FDRA Type 1 |

In some embodiments, when multiple UL Type-2 CGs are configured to the UE and when the UL transmission is one of multiple UL Type-2 CG transmissions corresponding to the multiple UL Type-2 CGs, and when the fourth message is generated for scheduling release, a HARQ process number field in the fourth message is set as a value of a ConfiguredGrantConfigIndex IE configured for the first UL Type-2 CG transmission, and the at least one field of the fourth message is set as at least one of: —RV field for a first TB is set to all ‘0’s when the DCI message is a DCI format 0_0 message; —RV field for a first TB is set to all ‘0’s when the DCI message is a DCI format 0_1 message; —RV field for a first TB is set to all ‘0’s when the DCI message is a DCI format 0_2 message; —RV field for a second TB is set to all ‘0’s when the DCI message is a DCI format 0_1 message; —RV field for a second TB is set to all ‘0’s when the DCI message is a DCI format 0_2 message; —MCS field is set to all ‘1’s when the DCI message is a DCI format 0_0 message; —MCS field is set to all ‘1’s when the DCI message is a DCI format 0_1 message; —MCS field is set to all ‘1’s when the DCI message is a DCI format 0_2 message; —FDRA field is set to all ‘0’s for FDRA Type 2 with μ=1 and/or set to all ‘1’s otherwise, when the DCI message is a DCI format 0_0 message; —FDRA field is set to all ‘0’s for FDRA Type 2 with μ=1 and/or set to all ‘1’s otherwise, when the DCI message is a DCI format 0_1 message; and —FDRA field is set to all ‘0’s for FDRA Type 2 with μ=1 and/or set to all ‘1’s otherwise, when the DCI message is a DCI format 0_2 message. For example, at least one field of the fourth message is set as follows:

| | DCI format | DCI format |
|---|---|---|
| | 0_0 | 0_1/0_2 |
| Redundancy version for | set to all ‘0’s | set to all ‘0’s |
| first TB | | |
| Redundancy version for | N/A | set to all ‘0’s |
| second TB | | |
| Modulation and coding scheme | set to all ‘1’s | set to all ‘1’s |
| Frequency domain resource | set to all ‘0’s for | set to all ‘0’s for |
| assignment | FDRA Type 2 | FDRA Type 2 |
| | with μ = 1 | with μ = 1 |
| | set to all ‘1’s, | set to all ‘1’s, |
| | otherwise | otherwise |

In some embodiments, the method further comprises: receiving, from the UE, a fifth message indicating whether DL transmission with multiple codewords and/or with more than 4 layers is supported by the UE or not. In some embodiments, the fifth message indicates at least one of: —whether DL SPS transmission with multiple codewords and/or with more than 4 layers is supported by the UE or not; and —whether DG based DL transmission with multiple codewords and/or with more than 4 layers is supported by the UE or not. In some embodiments, whether DL SPS transmission with multiple codewords and/or with more than 4 layers is supported by the UE or not is indicated by a third IE, wherein whether DG based DL transmission with multiple codewords and/or with more than 4 layers is supported by the UE or not is indicated by a fourth IE that is different from the third IE. In some embodiments, the fifth message is received when the UE is in the connected state.

In some embodiments, the fifth message further indicates whether the DL transmission with multiple codewords and/or with more than 4 layers can be scheduled by a DCI message of a specific format. In some embodiments, the specific format is DCI format 1_2 or another DCI format than DCI formats 1_0, 1_1, and 1_2. In some embodiments, the UL or DL transmission is PDSCH transmission or PUSCH transmission. In some embodiments, the network node comprises a TRP.

According to a fifth aspect of the present disclosure, a network node is provided. The network node comprises: a processor; a memory storing instructions which, when executed by the processor, cause the processor to perform the method of any of the fourth aspect.

According to a sixth aspect of the present disclosure, a network node is provided. The network node comprises: a transmitting module for transmitting, to a UE, a first message for scheduling UL or DL transmission with one or multiple codewords; and a performing module for performing, with the UE, the UL or DL transmission at least partially based on the first message.

According to a seventh aspect of the present disclosure, a computer program comprising instructions is provided. The instructions, when executed by at least one processor, cause the at least one processor to carry out the method of any of the first or fourth aspect.

According to an eighth aspect of the present disclosure, a carrier containing the computer program of the seventh aspect is provided. The carrier is one of an electronic signal, optical signal, radio signal, or computer readable storage medium.

According to a ninth aspect of the present disclosure, a telecommunications system is provided. The telecommunications system comprises at least one UE of the second or third aspect; and one or more network nodes of the fifth or sixth aspect.

With the above embodiments, transmission with multiple codewords may be achieved between a UE and a gNB, such that a higher throughput, a higher reliability, and a faster response for the uplink transmission may be achieved.

### BRIEF DESCRIPTION OF THE DRAWINGS

FIG. 1 is a diagram illustrating an exemplary NR time domain structure with 15 kHz subcarrier spacing with which a UE and gNB according to an embodiment of the present disclosure may be operable.

FIG. 2 is a diagram illustrating an exemplary NR physical resource grid with which a UE and gNB according to an embodiment of the present disclosure may be operable.

FIG. 3 is a diagram illustrating exemplary multiplexing of uplink control information (UCI) on PUSCH that is applicable to a UE and gNB according to an embodiment of the present disclosure.

FIG. 4 is a flow chart illustrating an exemplary method at a UE for transmission with multiple codewords according to an embodiment of the present disclosure.

FIG. 5 is a flow chart illustrating an exemplary method at a network node for transmission with multiple codewords according to an embodiment of the present disclosure.

FIG. 6 schematically shows an embodiment of an arrangement which may be used in a UE or a network node according to an embodiment of the present disclosure.

FIG. 7 is a block diagram of an exemplary UE according to an embodiment of the present disclosure.

FIG. 8 is a block diagram of an exemplary network node according to an embodiment of the present disclosure.

FIG. 9 schematically illustrates a telecommunication network connected via an intermediate network to a host computer according to an embodiment of the present disclosure.

FIG. 10 is a generalized block diagram of a host computer communicating via a base station with a user equipment over a partially wireless connection according to an embodiment of the present disclosure.

FIG. 11 to FIG. 14 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as transmission with multiple codewords is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, following 3GPP documents are incorporated herein by reference in their entireties:
3GPP TS 38.211 V16.6.0 (2021-06), 3rd Generation Partnership Project; Technical Specification Group Radio Access Network; NR; Physical channels and modulation (Release 16);
3GPP TS 38.212 V16.6.0 (2021-06), 3rd Generation Partnership Project; Technical Specification Group Radio Access Network; NR; Multiplexing and channel coding (Release 16);
3GPP TS 38.213 V16.6.0 (2021-06), 3rd Generation Partnership Project; Technical Specification Group Radio Access Network; NR; Physical layer procedures for control (Release 16); and
3GPP TS 38.214 V16.6.0 (2021-06), 3rd Generation Partnership Project; Technical Specification Group Radio Access Network; NR; Physical layer procedures for data (Release 16).

5G NR may use CP-OFDM (Cyclic Prefix-Orthogonal Frequency Division Multiplexing) in both downlink (DL) (i.e. from a network node, gNB, or base station, to a user equipment or UE) and uplink (UL) (i.e. from UE to gNB). Discrete Fourier Transform (DFT) spread OFDM may also be supported in the uplink. In the time domain, NR downlink and uplink may be organized into equally sized subframes of 1 ms each. A subframe may be further divided into multiple slots of equal duration. The slot length may depend on subcarrier spacing. For example, for subcarrier spacing of Δf=15 kHz, there is only one slot per subframe, and each slot may consist of 14 OFDM symbols.

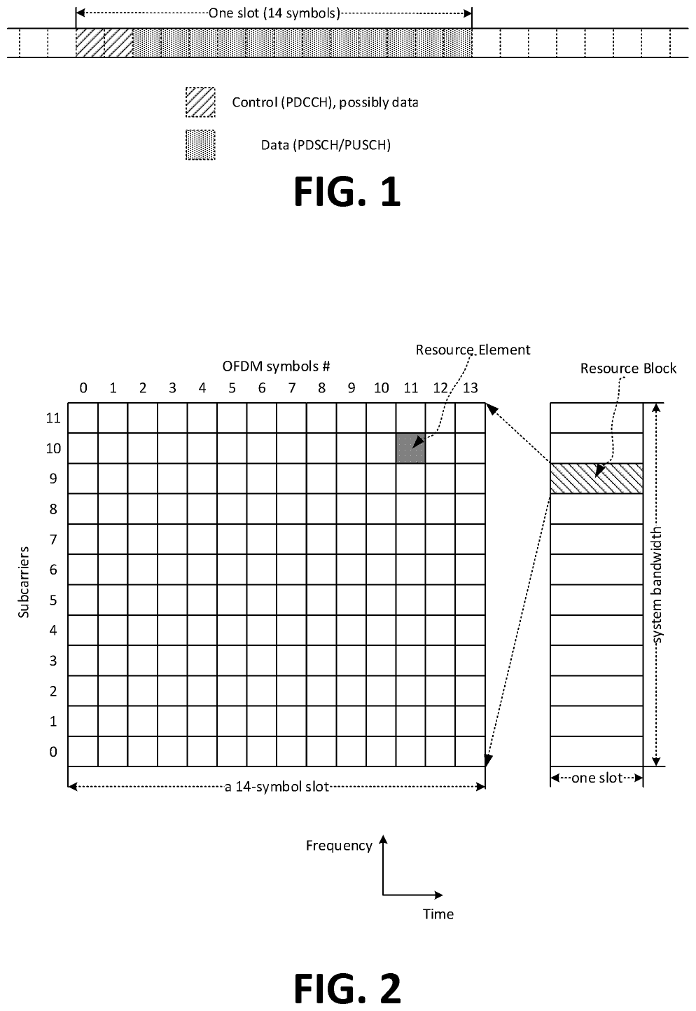

Data scheduling in NR is typically performed in a slot basis, and an example is shown in FIG. 1 with a 14-symbol slot. FIG. 1 is a diagram illustrating an exemplary NR time domain structure with 15 kHz subcarrier spacing with which a UE and gNB according to an embodiment of the present disclosure may be operable. As shown in FIG. 1, the first two symbols may contain PDCCH and the rest may contain physical shared data channel, either PDSCH or PUSCH.

Different subcarrier spacing values may be supported in NR. The supported subcarrier spacing values (also referred to as different numerologies) are given by Δf=(15×2^{μ}) kHz where μ∈ {0,1,2,3,4}. Δf=15 kHz is the basic subcarrier spacing.

The slot durations at different subcarrier spacings are given by

$$\frac{1}{{2}^{μ}}$$

ms.

In the frequency domain, a system bandwidth may be divided into resource blocks (RBs), each corresponding to 12 contiguous subcarriers. The RBs are numbered starting with 0 from one end of the system bandwidth. The basic NR physical time-frequency resource grid is illustrated in FIG. 2.

FIG. 2 is a diagram illustrating an exemplary NR physical resource grid with which a UE and gNB according to an embodiment of the present disclosure may be operable. As shown in FIG. 2, only one RB within a 14-symbol slot is shown. One OFDM subcarrier during one OFDM symbol interval forms one resource element (RE).

In NR Rel-15, uplink data transmission can be dynamically scheduled using PDCCH. A UE may first decode uplink grants in PDCCH and then transmit data over PUSCH based the decoded control information in the uplink grant such as modulation order, coding rate, uplink resource allocation, etc. In dynamic scheduling of PUSCH, there is also a possibility to configure semi-persistent transmission of PUSCH using configured grant (CG). There are two types of CG based PUSCH defined in NR Rel-15. In CG type 1, a periodicity of PUSCH transmission as well as the time domain offset may be configured by RRC. In CG type 2, a periodicity of PUSCH transmission may be configured by RRC and then the activation and release of such transmission may be controlled by DCI, i.e. with a PDCCH.

Further, in NR, it is possible to schedule a PUSCH with time repetition, by the RRC parameter pusch-AggregationFactor (for dynamically scheduled PUSCH), and repK (for PUSCH with UL configured grant). In this case, the PUSCH is scheduled but transmitted in multiple adjacent slots (if the slot is available for UL) up until the number of repetitions as determined by the configured RRC parameter.

In the case of PUSCH with UL configured grant, the redundancy version (RV) sequence to be used may be configured by the repK-RVfield when repetitions are used. If repetitions are not used for PUSCH with UL configured grant, then the repK-RVfield is absent.

In NR Release-15, there are two mapping types supported, Type A and Type B, applicable to PDSCH and PUSCH transmissions. Type A is usually referred to as slot-based while Type B transmissions may be referred to as non-slot-based or mini-slot-based.

Mini-slot transmissions can be dynamically scheduled and for NR Rel-15:
Can be of length 7, 4, or 2 symbols for downlink, while it can be of any length for uplink; and
Can start and end in any symbol within a slot.

Please Note that mini-slot transmissions in NR Rel-15 may not cross the slot-border.

Further, one of 2 frequency hopping modes, inter-slot and intra-slot frequency hopping, can be configured via higher layer for PUSCH transmission in NR Rel-15, in IE PUSCH-Config for dynamic transmission or IE configuredGrantConfig for type1 and type2 CG.

In the downlink, a gNB can dynamically allocate resources to UEs via the C-RNTI on PDCCH(s). A UE may always monitor the PDCCH(s) in order to find possible assignments when its downlink reception is enabled (activity governed by Discontinuous Reception (DRX) when configured). When carrier aggregation (CA) is configured, the same C-RNTI may apply to all serving cells.

The gNB may pre-empt an ongoing PDSCH transmission to one UE with a latency-critical transmission to another UE. The gNB can configure UEs to monitor interrupted transmission indications using INT-RNTI on a PDCCH. If a UE receives the interrupted transmission indication, the UE may assume that no useful information to that UE was carried by the resource elements included in the indication, even if some of those resource elements were already scheduled to this UE.

In addition, with Semi-Persistent Scheduling (SPS), the gNB can allocate downlink resources for the initial HARQ transmissions to UEs: RRC defines the periodicity of the configured downlink assignments while PDCCH addressed to CS-RNTI can either signal and activate the configured downlink assignment, or deactivate it. That is, a PDCCH addressed to CS-RNTI may indicate that the downlink assignment can be implicitly reused according to the periodicity defined by RRC, until deactivated.

Please note that, when required, retransmissions may be explicitly scheduled on PDCCH(s).

The dynamically allocated downlink reception may override the configured downlink assignment in the same serving cell, if they overlap in time. Otherwise a downlink reception according to the configured downlink assignment may be assumed, if activated.

The UE may be configured with up to 8 active configured downlink assignments for a given Bandwidth Part (BWP) of a serving cell. When more than one is configured:
The network may decide which of these configured downlink assignments are active at a time (including all of them); and
Each configured downlink assignment may be activated separately using a DCI command and deactivation of configured downlink assignments may be done using a DCI command, which can either deactivate a single configured downlink assignment or multiple configured downlink assignments jointly.

With Configured Grants, the gNB can allocate uplink resources for the initial HARQ transmissions and HARQ retransmissions to UEs.

As mentioned earlier, two types of configured uplink grants are defined:
With Type 1, RRC may directly provide the configured uplink grant (including the periodicity).
With Type 2, RRC may define the periodicity of the configured uplink grant while PDCCH addressed to CS-RNTI can either signal and activate the configured uplink grant, or deactivate it; i.e. a PDCCH addressed to CS-RNTI may indicate that the uplink grant can be implicitly reused according to the periodicity defined by RRC, until deactivated.

UCI may be reported from a UE to a gNB to assist the scheduling of PDSCH transmissions in downlink.

UCI on PUSCH can be ACK/NACK or Channel-state information (CSI) in the following ways, where different types of HARQ codebook are defined in section 9.1 of 38.213 V16.6.0, the DAI (downlink assignment index) is defined in the DCI format in 38.212 V16.6.0:
ACK/NACK with more than 2 bits and other UCI are rate matched, ACK/NACK with 1-2 bits is mapped via puncturing PUSCH data or CSI bits
   Due to code-block-group-based HARQ feedback, ACK/NACK size can be very large in NR→Puncturing large ACK/NACK into PUSCH leads to severe PUSCH performance degradation
DAI mechanism similar to LTE is used to indicate number of ACK/NACK bits for UCI on PUSCH
   DCI format 0_1 contains 1 bit UL DAI for fixed HARQ codebook, 2 bit UL DAI for dynamic HARQ codebook, and 2 bit UL DAI for dynamic HARQ codebook together with CBG configuration (one DAI for each sub-codebook)
   DCI format 0_0 does not contain any DAI
CSI can be split into two parts
Semi-statically configured and dynamically indicated beta values are supported
   Individual beta values can be set for ACK/NACK and CSI
   For dynamically indicated beta values, 2 bits in DCI format 0_1 select one value for ACK/NACK and CSI (n^{th} row in ACK/NACK and CSI table)

### Principles of UCI Mapping on PUSCH

CSI Part 1
   For rate matched ACK/NACK, CSI Part 1 is mapped from first available non-DM-RS symbol, mapping around ACK/NACK REs
   For puncturing ACK/NACK, CSI Part 1 is mapped from first available non-DM-RS symbol, mapping around those REs reserved for ACK/NACK puncturing (PUSCH and CSI Part 2 can be mapped on reserved resources, but will eventually be punctured)
CSI part 2 is mapped from first available non-DM-RS symbol, following CSI Part 1
   For puncturing ACK/NACK, CSI Part 2 can be mapped on resources reserved for ACK/NACK (and will then be punctured by ACK/NACK)
UCI is not FDMed (frequency division multiplexed) with DM-RS
Generally the following frequency-domain mapping procedure for all UCI types is used: Fill up symbol(s) completely with modulation symbols of one UCI type (if enough UCI modulation symbols are available); This is followed by one symbol where remaining UCI modulation symbols of this type are mapped on a comb across PUSCH bandwidth.

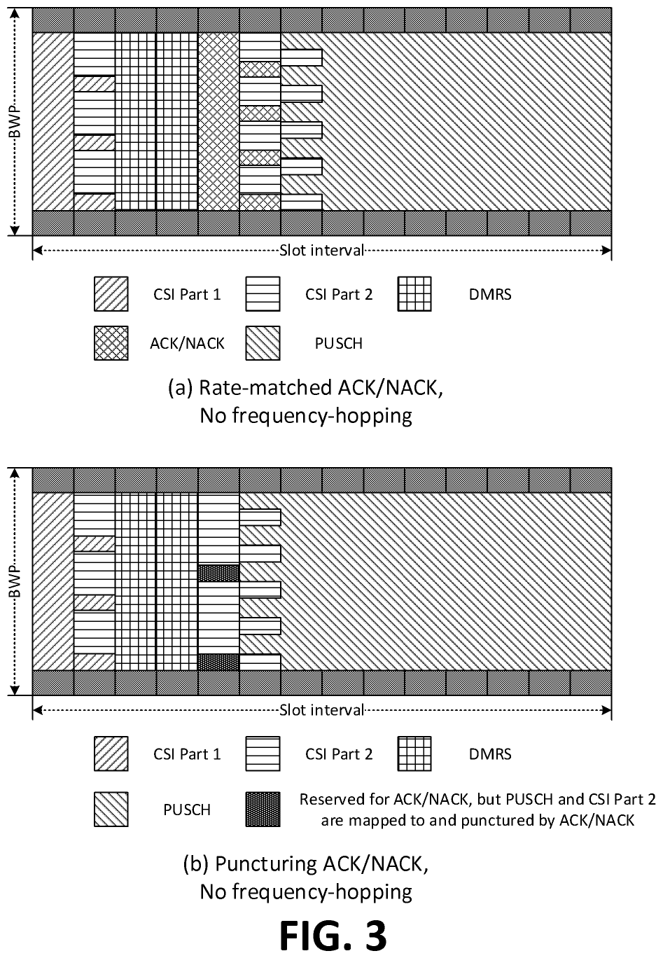

FIG. 3 is a diagram illustrating exemplary multiplexing of UCI on PUSCH that is applicable to a UE and gNB according to an embodiment of the present disclosure. As shown in FIG. 3, an example where ACK/NACK is rate matched around is shown in (a) and another example where ACK/NACK is mapped via puncturing PUSCH data or CSI bits is shown in (b).

From 3GPP TS 38.213 v16.6.0:

If a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills the conditions in cause 9.2.5 for multiplexing the HARQ-ACK and/or CSI information, the UE multiplexes the HARQ-ACK and/or CSI information in the PUSCH transmission in the one or more slots. The UE does not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent.

The following is captured in 3GPP TS 38.212 v16.6.0 with regards to rate matching, where the beta offset values are defined for a UE to determine a number of resources for multiplexing HARQ-ACK information and for multiplexing CSI reports in a PUSCH with details defined in section 9.3 of 38.213 V16.6.0:

```
6.3.2.4 Rate matching
6.3.2.4.1 UCI encoded by Polar code
6.3.2.4.1.1 HARQ-ACK
For HARQ-ACK transmission on PUSCH with UL-SCH, the number of coded modulation symbols per
layer for HARQ-ACK transmission, denoted as Q′_{ACK} , is determined as follows:
$where {Q}_{ACK}^{{}_{} ′} = min \{ ⌈ \frac{( {O}_{ACK} + {L}_{ACK} ) \cdot {β}_{offset}^{{}_{} PUSCH} \cdot {\sum }_{l = {l}_{0}}^{{N}_{symb , all}^{{}_{} PUSCH} - 1} {M}_{sc}^{{}_{} UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{{}_{} PUSCH} - 1} {M}_{sc}^{{}_{} UCI} ( l ) ⌉ \}$
  - O_{ACK} is the number of HARQ-ACK bits;
  - if O_{ACK} ≥ 360, L_{ACK} = 11; otherwise L_{ACK} is the number of CRC bits for HARQ-ACK determined
      according to Clause 6.3.1.2.1 of 3GPP TS 38.212 v16.6.0;
  - β_{offset}^{PUSCH} = β_{offset}^{HARQ-ACK};
  - C_{UL-SCH} is the number of code blocks for UL-SCH of the PUSCH transmission;
  - if the DCI format scheduling the PUSCH transmission includes a CBGTI field indicating that the UE shall
      not transmit the ᵣ-th code block, Kᵣ = 0; otherwise, Kᵣ is the ᵣ-th code block size for UL-SCH of the
      PUSCH transmission;
  - M_{sc}^{PUSCH} is the scheduled bandwidth of the PUSCH transmission, expressed as a number of subcarriers;
  - M_{sc}^{PT-RS}(l) is the number of subcarriers in OFDM symbol l that carries PTRS, in the PUSCH transmission;
  - M_{sc}^{UCI} (l) is the number of resource elements that can be used for transmission of UCI in OFDM symbol l,
      for l = 0, 1, 2, ... , N_{symb,all}^{PUSCH} −1, in the PUSCH transmission and N_{symb,all}^{PUSCH} is the total number of
      OFDM symbols of the PUSCH, including all OFDM symbols used for DMRS;
      - for any OFDM symbol that carries DMRS of the PUSCH, M_{sc}^{UCI}(l) = 0;
      - for any OFDM symbol that does not carry DMRS of the PUSCH, M_{sc}^{UCI}(1) = M_{sc}^{PUSCH} − M_{sc}^{PT-RS}(1);
  - _{α} is configured by higher layer parameter scaling;
  - l₍ is the symbol index of the first OFDM symbol that does not carry DMRS of the PUSCH, after the first
      DMRS symbol(s), in the PUSCH transmission.
For HARQ-ACK transmission on PUSCH without UL-SCH, the number of coded modulation symbols
per layer for HARQ-ACK transmission, denoted as Q′_{ACK}, is determined as follows:
$where {Q}_{ACK}^{{}_{} ′} = min \{ ⌈ \frac{( {O}_{ACK} + {L}_{ACK} ) \cdot {β}_{offset}^{{}_{} PUSCH}}{R \cdot {Q}_{m}} ⌉ , ⌈ α \cdot {\sum }_{l = {l}_{0}}^{{N}_{symb , all}^{{}_{} PUSCH} - 1} {M}_{sc}^{{}_{} UCI} ( l ) ⌉ \}$
  - O_{ACK} is the number of HARQ-ACK bits;
  - if O_{ACK} ≥ 360, L_{ACK} =11; otherwise L_{ACK} is the number of CRC bits for HARQ-ACK defined according
      to Clause 6.3.1.2.1;;
  - β_{offset}^{PUSCH} = β_{offset}^{HARQ-ACK};
  - M_{sc}^{PUSCH} is the scheduled bandwidth of the PUSCH transmission, expressed as a number of subcarriers;
  - M_{sc}^{PT-RS}(l) is the number of subcarriers in OFDM symbol l that carries PTRS, in the PUSCH transmission;
  - M_{sc}^{UCI}(l) is the number of resource elements that can be used for transmission of UCI in OFDM symbol I,
for 1 = 0, 1, 2, ... , N_{symb,all}^{PUSCH} −1, in the PUSCH transmission and N_{symb,all}^{PUSCH} is the total number of
      OFDM symbols of the PUSCH, including all OFDM symbols used for DMRS;
      - for any OFDM symbol that carries DMRS of the PUSCH, M_{sc}^{UCI}(l) = 0;
      - for any OFDM symbol that does not carry DMRS of the PUSCH, M_{sc}^{UCI}(1) = M_{sc}^{PUSCHI} - M_{sc}^{PT-RS}(l);
  - l₎ is the symbol index of the first OFDM symbol that does not carry DMRS of the PUSCH, after the first
      DMRS symbol(s), in the PUSCH transmission;
  - _{R} is the code rate of the PUSCH, determined according to Clause 6.1.4.1 of [6, TS38.214];
  - Qₘ is the modulation order of the PUSCH;
  - _{α} is configured by higher layer parameter scaling.
```

Further, in NR R16, PHY prioritization between UL transmissions of different PHY priority index is introduced in 3GPP to address resource conflicts between DG PUSCH and CG PUSCH and conflicts involving multiple CGs and also to address UL data/control and control/control resource collision.

Rel-16 supports a two-level PHY priority index indication of:
Scheduling Request (SR): SR configuration may have a PHY priority index indication as an RRC field in SR resource configuration.
   Note: PHY priority index is only used to let PHY know the priority. MAC will perform prioritization based on LCH priorities.
HARQ-ACK: PHY priority index may be indicated in DL DCI (Formats 1_1 and 1_2) for dynamic assignments and for CG PUSCH the PHY priority index may be indicated by RRC configuration.
PUSCH: For DG PUSCH, PHY priority index may be indicated in UL DCI (Formats 0_1 and 0_2), and for CG PUSCH, the PHY priority index may be indicated by CG PUSCH configuration.
A-periodic and semi-persistent CSI on PUSCH: PHY priority index may be indicated in UL DCI (Formats 0_1 and 0_2).
Low PHY priority index is assumed for periodic and semi-persistent CSI on PUCCH, periodic and semi-persistent SRS and when PHY priority index is not indicated.
Aperiodic SRS is always of low priority.

PHY priority index 0 may be defined as low priority and PHY priority index 1 is defined as high priority.

In Rel-16, UCI may be multiplexed in a PUCCH or a PUSCH only if PHY priority index of UCI and the PHY priority index of PUCCH or PUSCH is the same. Certain combinations of multiplexing UCI and PUSCH of different priorities are expected to be supported in Rel-17, for example, multiplexing a high-priority HARQ-ACK and a low-priority HARQ-ACK into a PUCCH, multiplexing a low-priority HARQ-ACK in a high-priority PUSCH, etc.

The Rel-16 intra-UE PHY prioritization first resolves time-overlapping for PUCCH and/or PUSCH transmissions for same PHY priority, then time-overlapping between priorities is resolved, where the lower-priority PUCCH/PUSCH is not transmitted if it is time-overlapping with a higher-priority PUCCH/PUSCH transmission. Here, it should be emphasized that UE does not resolve time-overlapping for PUCCH/PUSCH transmissions of high-priority before resolving time-overlapping between priorities. This means that UE will cancel a low-priority PUCCH/PUSCH transmission that time-overlaps with a high-priority PUCCH but not with a high-priority PUSCH that time-overlap with the high-priority PUCCH although the high-priority PUCCH will not be sent since UCI would be multiplexed on the high-priority PUSCH.

Rel-16 also supports 2 HARQ codebooks and both can be slot/sub-slot based or can be different (Each codebook is separately configured).
Two HARQ-ACK CodeBooks (CBs) can be configured
   1st HARQ-ACK CB↔PHY priority index 0
   2nd HARQ-ACK CB↔PHY priority index 1
Two PUCCH configurations
   1st PUCCH↔1st HARQ-ACK CB
   2nd PUCCH↔2nd HARQ-ACK CB
   Each PUCCH can be slot or sub-slot configured
Two UCI-OnPUSCH (one per HARQ-ACK codebook)
   i.e., Beta-factor for HARQ-ACK (and CSI) per PHY priority index

Further, in NR up to Release 17, 2 codewords are supported for PDSCH transmission and only single codeword is supported for PUSCH transmission. Up to 4 transmission layers are supported in uplink while up to 8 transmission layers are supported in downlink. When 2 codewords are used in downlink, the number of transmission layers shall be greater than 4. When the number of transmission layers is less than or equal to 4, a single codeword may be used in the downlink in NR up to Rel-17. The codeword to layer mapping assumed in NR is shown in Table 1.

TABLE 1
Codeword-to-layer mapping for spatial multiplexing.

| Number of | Number of | Codeword-to-layer mapping | |
|---|---|---|---|
| layers | codewords | i = 0, 1, . . . , M_{symb}^{layer} − 1 | |
| 1 | 1 | x⁽⁰⁾(i) = d⁽⁰⁾(i) | M_{symb}^{layer} = M_{symb}⁽⁰⁾ |
| 2 | 1 | x⁽⁰⁾(i) = d⁽⁰⁾(2i) | M_{symb}^{layer} = M_{symb}⁽⁰⁾/2 |
| | | x⁽¹⁾(i) = d⁽⁰⁾(2i + 1) | |
| 3 | 1 | x⁽⁰⁾(i) = d⁽⁰⁾(3i) | |
| | | x⁽¹⁾(i) = d⁽⁰⁾(3i + 1) | M_{symb}^{layer} = M_{symb}⁽⁰⁾/3 |
| | | x⁽²⁾(i) = d⁽⁰⁾(3i + 2) | |
| 4 | 1 | x⁽⁰⁾(i) = d⁽⁰⁾(4i) | M_{symb}^{layer} = M_{symb}⁽⁰⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| 5 | 2 | x⁽⁰⁾(i) = d⁽⁰⁾(2i) | M_{symb}^{layer} = M_{symb}⁽⁰⁾/2 = M_{symb}⁽¹⁾/3 |
| | | x⁽¹⁾(i) = d⁽⁰⁾(2i + 1) | |
| | | x⁽²⁾(i) = d⁽¹⁾(3i) | |
| | | x⁽³⁾(i) = d⁽¹⁾(3i + 1) | |
| | | x⁽⁴⁾(i) = d⁽¹⁾(3i + 2) | |
| 6 | 2 | x⁽⁰⁾(i) = d⁽⁰⁾(3i) | M_{symb}^{layer} = M_{symb}⁽⁰⁾/3 = M_{symb}⁽¹⁾/3 |
| | | x⁽¹⁾(i) = d⁽⁰⁾(3i + 1) | |
| | | x⁽²⁾(i) = d⁽⁰⁾(3i + 2) | |
| | | x⁽³⁾(i) = d⁽⁰⁾(3i) | |
| | | x⁽⁴⁾(i) = d⁽¹⁾(3i + 1) | |
| | | x⁽⁵⁾(i) = d⁽¹⁾(3i + 2) | |
| 7 | 2 | x⁽⁰⁾(i) = d⁽⁰⁾(3i) | M_{symb}^{layer} = M_{symb}⁽⁰⁾/3 = M_{symb}⁽¹⁾/4 |
| | | x⁽¹⁾(i) = d⁽⁰⁾(3i + 1) | |
| | | x⁽²⁾(i) = d⁽⁰⁾(3i + 2) | |
| | | x⁽³⁾(i) = d⁽¹⁾(4i) | |
| | | x⁽⁴⁾(i) = d⁽¹⁾(4i + 1) | |
| | | x⁽⁵⁾(i) = d⁽¹⁾(4i + 2) | |
| | | x⁽⁶⁾(i) = d⁽¹⁾(4i + 3) | |
| 8 | 2 | x⁽⁰⁾(i) = d⁽⁰⁾(4i) | M_{symb}^{layer} = M_{symb}⁽⁰⁾/4 = M_{symb}⁽¹⁾/4 |
| | | x⁽¹⁾(i) = d⁽⁰⁾(4i + 1) | |
| | | x⁽²⁾(i) = d⁽⁰⁾(4i + 2) | |
| | | x⁽³⁾(i) = d⁽⁰⁾(4i + 3) | |
| | | x⁽⁴⁾(i) = d⁽¹⁾(4i) | |
| | | x⁽⁵⁾(i) = d⁽¹⁾(4i + 1) | |
| | | x⁽⁶⁾(i) = d⁽¹⁾(4i + 2) | |
| | | x⁽⁷⁾(i) = d⁽¹⁾(4i + 3) | |

In NR only one codeword (or one transport block) up to 4 layers can be used for PDSCH scheduled/activated by DCI 1_2, and only 1 HARQ-ACK bit is generated for one SPS configuration in each PDSCH transmission occasion configured by the SPS configuration.

When more than one codeword is used, separate configurations in SPS for the 2nd or additional codeword are needed for PDSCH scheduled/activated by DCI 1_2. This also has impacts on HARQ-ACK feedback for SPS and PDCCH validation for SPS activation and deactivation. Therefore, how to address the impacts is a problem.

Further, the PDCCH validation for UL CG activation and deactivation also needs to be considered when multiple codewords are supported for CG Type 2 PUSCH transmissions in uplink.

Further, UE capability of support multiple codeword on SPS PDSCH transmission should be reported so that the network can schedule the transmission accordingly.

Some embodiments of the present disclosure may provide methods on how to support multiple codewords transmission in DL SPS PDSCH or CG Type 2 PUSCH in NR in the following aspects:
configuring and activating 2 or more codewords for a DL SPS;
Signaling 2 or more codewords with extended DCI format 1_2 or a new DCI format;
A modified HARQ-ACK procedure for DL SPS with two or more codewords;
An enhanced validation method for validation of SPS and/or CG Type 2 activation and release by using additional values of bit fields associated with the second or other additional codeword; and
A new UE capability signaling in supporting two or mode codewords (CWs) for SPS.

With the embodiments of the present disclosure, methods on how to support multiple codewords transmission in SPS PDSCH or CG Type 2 PUSCH in NR may be provided.

In some embodiments, the term “multiple codewords” may refer to 2 or more codewords transmission on one PUSCH channel or a PDSCH channel, which can also be viewed as multiple transport blocks (TBs), since one codeword corresponds to one transport block (TB).

In some embodiments, the term “DG PDSCH” may refer to the dynamic grant scheduled PDSCH, where a PDSCH transmission is scheduled by a corresponding DL scheduling DCI. In some embodiments, the term “SPS PDSCH” may refer to the PDSCH is semi-persistently scheduled, where a PDSCH is transmitted without a corresponding DL scheduling DCI, after the SPS (semi-persistent scheduling) configuration is activated.

In some embodiments, if maxNrofCodeWordsScheduledByDCI=2 is configured in a DL bandwidth part (BWP), a DL SPS may be:
configured to the UE with one or two codewords via RRC signaling; and/or
assumed by the UE to have 2 codewords, but one of the codewords can be disabled via specific one or more fields configured to the UE with predetermined values; and/or
   For example, if I_{MCS}=26 and if rv_{id}=1 are configured, the corresponding codeword may be disabled.
or assumed by the UE to always have 2 codewords.

In some embodiments, if multiple DL SPS configurations are configured to the UE, each DL SPS can be configured individually with either one or two or more codewords.

In some embodiments, if a DL SPS is configured to the UE with two or more codewords, one, two, or more codewords may be enabled during the DL SPS activation with DCI format 1_1. If the DL SPS is activated by other DCI formats, such as DCI format 1_0, only one codeword may be activated.

In some embodiments, the DCI format 1_2 may be extended to support two or more downlink transport blocks (or codewords) on a PDSCH. Up to Rel-17, DCI format 1_2 only supports the transmission of a single TB (i.e., a single codeword).

For example, an RRC parameter maxNrofCodeWordsScheduledByDCI-1-2 can be configured to the UE indicating the maximum number of codewords that a single DCI of format 1_2 may schedule. The parameter maxNrofCodeWordsScheduledByDCI-1-2 can take value 1 or 2. If the parameter maxNrofCodeWordsScheduledByDCI-1-2 has a value of 2 (i.e., value n2 in the example ASN.1 code shown below), then up to two codewords can be scheduled by a DCI of format 1_2. The parameter maxNrofCodeWordsScheduledByDCI-1-2 can be configured to the UE from the gNB as part of the PDSCH-Config information element.
maxNrofCodeWordsScheduledByDCI-1-2 ENUMERATED {n1, n2} OPTIONAL, —Need R

When maxNrofCodeWordsScheduledByDCI-1-2 is configured to the UE with a value of 2, a second set of ‘Modulation and coding scheme’, ‘New data indicator’, and ‘Redundancy version’ fields may be included in DCI format 1_2 as shown below (the newly added DCI fields are underlined below). The second set of fields may be applicable to the 2^{nd} transport block (i.e., 2^{nd} codeword). The below change with newly added fields may be captured in 3GPP TS 38.212.

7.3.1.2.3 Format 1_2
DCI format 1_2 is used for the scheduling of PDSCH in one cell.
The following information is transmitted by means of the DCI format 1_2 with CRC scrambled by C-RNTI or
CS-RNTI or MCS-C-RNTI:
...

| | |
|---|---|
| - | ZP CSI-RS trigger - 0, 1, or 2 bits as defined in Clause 5.1.4.2 of [6, TS 38.214]. The bitwidth for this |
| | field is determined as ┌log₂(n_{ZP} + 1)┐ bits, where n_{ZP} is the number of aperiodic ZP CSI-RS resource |
| | sets configured by higher layer parameter aperiodicZP-CSI-RS-ResourceSetsToAddModListDCI-1-2. |

For transport block 1:

| | |
|---|---|
| - | Modulation and coding scheme - 5 bits as defined in Clause 5.1.3.1 of [6, TS 38.214] |
| - | New data indicator - 1 bit |
| - | Redundancy version - 0, 1 or 2 bits determined by higher layer parameter numberOfBitsForRV-DCI-1-2 |
| | - If 0 bit is configured, rv_{id} to be applied is 0; |
| | - 1 bit according to Table 7.3.1.2.3-1; |
| | - 2 bits according to Table 7.3.1.1.1-2. |

For transport block 2 (only present if maxNrofCodeWordsScheduledByDCI-1-2 equals 2):

| | |
|---|---|
| - | Modulation and coding scheme - 5 bits as defined in Clause 5.1.3.1 of [6, TS 38.214] |
| - | New data indicator - 1 bit |
| - | Redundancy version - 0, 1 or 2 bits determined by higher layer parameter numberOfBitsForRV- |
| | DCI-1-2 |
| | - If 0 bit is configured, rv_{id} to be applied is 0; |
| | - 1 bit according to Table 7.3.1.2.3-1; |
| | - 2 bits according to Table 7.3.1.1.1-2. |
| - | HARQ process number - 0, 1, 2, 3 or 4 bits determined by higher layer parameter harq- |
| | ProcessNumberSizeDCI-1-2 |

...

In some embodiments, a new DCI format different from DCI format 1_1 and DCI format 1_2 may be introduced to support two or more downlink transport blocks on a PDSCH.

For example, a DCI format 1_3 can be introduced to support high throughput with higher reliability, which may be needed for use case of XR (Extended Reality).

Up to Rel-17, for one SPS PDSCH of one SPS configuration, only one HARQ-ACK bit is generated.

In some embodiments, when SPS PDSCH is to support two or more codewords (i.e., two or more TBs), then two or more HARQ-ACK bits may be provided for one SPS PDSCH of one SPS configuration. Thus, one or more of the following HARQ-ACK codebook construction may be enhanced:
HARQ-ACK CB (codebook) that contains HARQ-ACK for SPS only. That is, it does not contain HARQ-ACK for PDSCH with a corresponding scheduling DCI.
Type-1 HARQ-ACK CB;
Type-2 HARQ-ACK CB; and
Type-3 HARQ-ACK CB.

In current specification, the pseudo-code for HARQ-ACK of SPS is as following:

| | |
|---|---|
| 9.1.2 | Type-1 HARQ-ACK codebook determination |

```
...
Set c = 0 − serving cell index: lower indexes correspond to lower RRC indexes of corresponding cell
  while c < N_{cells}^{NDL}
  Set s = 0 − SPS PDSCH configuration index: lower indexes correspond to lower RRC indexes of corresponding
    SPS configurations
    while s < N_{c}^{SPS}
      Set n_{D} = 0 − slot index
```

```
while n_{D} < N_{c}^{DL}
  if {
    a UE is configured to receive SPS PDSCHs from slot n_{D} − N_{PDSCH}^{repeat} + 1 to slot n_{D} for SPS
    PDSCH configuration s on serving cell c, excluding SPS PDSCHs that are not required to be
    received in any slot among overlapping SPS PDSCHs, if any according to [6, TS 38.214], or
    based on a UE capability for a number of PDSCH receptions in a slot according to [6, TS
    38.214], or due to overlapping with a set of symbols indicated as uplink by tdd-UL-DL-
    ConfigurationCommon or by tdd-UL-DL-ConfigurationDedicated where N_{PDSCH}^{repeat} is provided
    by pdsch-AggregationFactor-r16 in sps-Config or, if pdsch-AggregationFactor-r16 is not
    included in sps-Config, by pdsch-AggregationFactor in pdsch-config, and
    HARQ-ACK information for the SPS PDSCH is associated with the PUCCH
    }
    õⱼ^{ACK} = HARQ-ACK information bit for this SPS PDSCH reception
    j = j + 1;
  end if
  n_{D} = n_{D} + 1;
end while
s = s + 1;
```

```
    end while
    c = c + 1;
  end while
```

In some embodiments, proposed changes to the pseudo code in 3 gpp TS 38.213 v16.6.0 section 9.1.2 can be:

9.1.2 Type-1 HARQ-ACK codebook determination
----------unchanged text omitted--------------
Set N_{cells}^{DL} to the number of serving cells configured to the UE
Set N_{c}^{SPS} to the number of SPS PDSCH configuration configured to the UE for serving cell c
Set N_{c}^{DL} to the number of DL slots for SPS PDSCH reception on serving cell c with HARQ-ACK information
multiplexed on the PUCCH
Set j = 0 HARQ-ACK information bit index
Set c = 0 − serving cell index: lower indexes correspond to lower RRC indexes of corresponding cell

| | |
|---|---|
| ♦ | while c < N_{cells}^{DL} |
| ♦ | Set s = 0 − SPS PDSCH configuration index: lower indexes correspond to lower RRC indexes of |
| | corresponding SPS configurations |
| | while s < N_{c}^{SPS} |
| | Set n_{D} = 0 − slot index |
| | while n_{D} < N_{c}^{DL} |
| | if { |
| | a UE is configured to receive SPS PDSCHs from slot n_{D} − N_{PDSCH}^{repeat} + 1 to slot n_{D} for SPS |
| | PDSCH configuration s on serving cell c, excluding SPS PDSCHs that are not required to be |
| | received in any slot among overlapping SPS PDSCHs, if any according to [6, TS 38.214], or |
| | based on a UE capability for a number of PDSCH receptions in a slot according to [6, TS |
| | 38.214], or due to overlapping with a set of symbols indicated as uplink by tdd-UL-DL- |
| | ConfigurationCommon or by tdd-UL-DL-ConfigurationDedicated where N_{PDSCH}^{repeat} is provided |
| | by pdsch-AggregationFactor-r16 in sps-Config or, if pdsch-AggregationFactor-r16 is not |
| | included in sps-Config, by pdsch-AggregationFactor in pdsch-config, and |
| | HARQ-ACK information for the SPS PDSCH is associated with the PUCCH |
| | } |
| | If the SPS is activated with two transport blocks |
| | õⱼ^{ACK} = HARQ-ACK information bit corresponding to a first transport block for this |
| | SPS PDSCH reception |
| | j = j + 1; |
| | õⱼ^{ACK} = HARQ-ACK information bit corresponding to a second transport block for |
| | this SPS PDSCH reception |
| | j = j + 1; |
| | Elseif the SPS is activated with one transport block |
| | õⱼ^{ACK} = HARQ-ACK information bit for this SPS PDSCH reception |
| | j = j + 1; |
| | end |
| | end if |
| | n_{D} = n_{D} + 1; |
| | end while |
| | s = s + 1; |
| | end while |
| | c = c + 1; |
| ♦ | end while |

--------------------------------------------------end of proposed changes--------------------------------------

In some embodiments, the 2 or more HARQ-ACK bits for 2 or more codewords of SPS PDSCH transmission can be bundled, which can be RRC configured to the UE, predetermined, or specified as part of 3GPP specifications. In some embodiments, the bundling operation may be a binary AND operation of the HARQ-ACK information bits corresponding to first and second or more transport blocks in one SPS.

For example, following 2 parameters, for HARQ feedback on PUCCH and PUSCH respectively, may be configured to the UE to determine whether the 2 bit HARQ-ACK should be bundled when 2 codewords are enabled for one SPS. If SPS-harq-ACK-SpatialBundlingPUCCH is provided, bundling is used for the 2 HARQ-ACK bits transmitted on PUCCH, otherwise, no bundling. If SPS-harq-ACK-SpatialBundlingPUSCH is provided, bundling is used for the 2 bit HARQ-ACK transmitted on PUSCH, otherwise, no bundling.

| | | | |
|---|---|---|---|
| SPS-harq-ACK-SpatialBundlingPUCCH | ENUMERATED {true} | OPTIONAL, | -- Need S |
| SPS-harq-ACK-SpatialBundlingPUSCH | ENUMERATED {true} | OPTIONAL, | -- Need S |

In some embodiments, if the UE is configured with two or more codewords for a single SPS PDSCH, activation of the SPS PDSCH (with two or more codewords) may need to be validated. This validation can be done when the redundancy version field corresponding to the 2^{nd} or additional TB in the activating DCI is set to all ‘0’s. This is in addition to the following special fields that are already set to ‘0’s:
redundancy version field corresponding to the 1st TB; and/or
HARQ process number field.

In some embodiments, a similar validation method as described in the above embodiments can also be applicable while activating a single CG type 2 (i.e., UL grant Type 2) PUSCH when the UE is configured with two or more uplink codewords for the CG type 2 PUSCH.

For example, Table 2 shows the special validation fields for activation PDCCH validation for the case when the UE is provided a single DL SPS PUSCH or single CG type 2 PUSCH when two codewords are configured to the UE. Note that the two codewords (i.e., two TBs) scheduling is only possible when activating DCI has the following formats:
DCI format 1_1 or DCI format 1_2 when activating DL SPS PUSCH;
DCI format 0_1 or DCI format 0_2 when activating CG type 2 PUSCH.

TABLE 2
Special fields for single DL SPS or single UL grant
Type 2 scheduling activation PDCCH validation when
a UE is provided a single SPS PDSCH or UL grant Type
2 configuration with two configured codewords (or
TBs) in the active DL/UL BWP of the scheduled cell

| | DCI format | DCI format |
|---|---|---|
| | 0_0/1_0 | 0_1/0_2/1_1/1_2 |
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |

In some embodiments, when the UE is configured with two or more codewords for a single SPS PDSCH, release of such a SPS PDSCH (with two or more codewords) may need to be validated. This validation can be done when the redundancy version field corresponding to the 2^{nd} or additional TB in the releasing DCI is set to all ‘0’s and/or the modulation and coding scheme corresponding to the 2^{nd} TB is set to all ‘1’s. One or more of these two special field settings are in addition to the validation fields that are already set to the following values:
redundancy version field corresponding to the 1st TB set to all ‘0’s; and/or
HARQ process number field set to all ‘0’s; and/or
Modulation and coding scheme.

In some embodiments, a similar validation method described in the above embodiments can also be applicable while releasing CG type 2 (i.e., UL grant Type 2) PUSCH when the UE is configured with two or more uplink codewords for CG type 2 PUSCH.

For example, Table 3 shows the special validation fields for the case when the UE is provided a single DL SPS PUSCH or single CG type 2 PUSCH when two codewords (i.e., two TBs) are configured to the UE. Note that the two codeword scheduling is only possible when releasing DCI has the following formats:
DCI format 1_1 or DCI format 1_2 when releasing DL SPS PUSCH;
DCI format 0_1 or DCI format 0_2 when releasing CG type 2 PUSCH.

TABLE 3
Special fields for single DL SPS or single UL grant Type 2 scheduling release PDCCH
validation when a UE is provided a single SPS PDSCH or UL grant Type 2 configuration
with two configured codewords (or TBs) in the active DL/UL BWP of the scheduled cell

| | DCI format | DCI format | DCI format | DCI format |
|---|---|---|---|---|
| | 0_0 | 1_0 | 0_1/0_2 | 1_1/1_2 |
| HARQ process number | set to all ‘0’s | set to all ‘0’s | set to all ‘0’s | set to all ‘0’s |
| Redundancy version for | set to all ‘0’s | set to all ‘0’s | set to all ‘0’s | set to all ‘0’s |
| first TB | | | | |
| Redundancy version for | N/A | N/A | set to all ‘0’s | set to all ‘0’s |
| second TB | | | | |
| Modulation and coding | set to all ‘1’s | set to all ‘1’s | set to all ‘1’s | set to all ‘1’s |
| scheme for first TB | | | | |
| Modulation and coding | N/A | N/A | set to all ‘1’s | set to all ‘1’s |
| scheme for second TB | | | | |
| Frequency domain | set to all ‘0’s for | set to all ‘0’s for | set to all ‘0’s for | set to all ‘0’s for |
| resource assignment | FDRA Type 2 | FDRA Type 0 or for | FDRA Type 2 | FDRA Type 0 or for |
| | with μ = 1 | dynamicSwitch | with μ = 1 | dynamicSwitch |
| | set to all ‘1’s, | set to all ‘1’s for | set to all ‘1’s, | set to all ‘1’s for |
| | otherwise | FDRA Type 1 | otherwise | FDRA Type 1 |

In current 3GPP specifications, if a UE is provided more than one configuration for UL grant Type 2 PUSCH or for SPS PDSCH, a value of the HARQ process number field in a DCI format may indicate an activation for a corresponding UL grant Type 2 PUSCH or for a SPS PDSCH configuration with a same value as provided by ConfiguredGrantConfigIndex or by sps-ConfigIndex, respectively. Validation of the DCI format may be achieved if the RV field for the DCI format is set as in Table 10.2-3 of 38.213 v16.6.0.

In some embodiments, if the UE is configured with two or more codewords for each SPS PDSCH when multiple SPS configurations are configured, activation of the SPS PDSCH (with two or more codewords) needs to be validated. This validation can be done when the redundancy version field corresponding to the 2^{nd} or additional TB in the activating DCI is set to all ‘0’s and the HARQ process number is equal to the corresponding SPS PDSCH configuration. This is in addition to the following special fields that are already set to ‘0’s:
redundancy version field corresponding to the 1^{st} TB.

In some embodiments, a similar validation method as described in the above embodiments can also be applicable while activating a single CG type 2 (i.e., UL grant Type 2) PUSCH when the UE is configured with two uplink codewords (i.e., two uplink TBs) for the CG type 2 PUSCH and when multiple CG configurations are provided.

An example is illustrated by Table 4 for SPS/CG Type 2 activation when 2 codewords and multiple SPS/UL grant type 2 configurations are provided.

TABLE 4
Special fields for a single DL SPS or single UL grant
Type 2 scheduling activation PDCCH validation when a
UE is provided multiple DL SPS or UL grant Type 2 configurations
in the active DL/UL BWP of the scheduled cell

| | DCI format | DCI format |
|---|---|---|
| | 0_0/1_0 | 0_1/0_2/1_1/1_2 |
| Redundancy version for | set to all ‘0’s | set to all ‘0’s |
| first TB | | |
| Redundancy version for | N/A | set to all ‘0’s |
| second TB | | |

In some embodiments, when the UE is configured with two or more codewords for a single SPS PDSCH when multiple SPS configurations are configured, release of such a SPS PDSCH (with two or more codewords) may need to be validated. This validation can be done when the redundancy version field corresponding to the 2^{nd} or additional TB in the releasing DCI is set to all ‘0’s and/or the modulation and coding scheme corresponding to the 2^{nd} TB is set to all ‘1’s and the HARQ process number equal to the corresponding SPS PDSCH configuration. One or more of these two special field settings are in addition to the validation fields that are already set to the following values:
redundancy version field corresponding to the 1st TB set to all ‘0’s;
Modulation and coding scheme set to all “1”s; and/or
Frequency domain resource assignment set to all ‘1’s or ‘0’s based on Table 5.

In some embodiments, a similar validation method described in the above embodiments can also be applicable while releasing CG type 2 (i.e., UL grant Type 2) PUSCH when the UE is configured with two uplink codewords for CG type 2 PUSCH and when multiple CG PUSCH configurations are configured.

An example is illustrated by Table 5 for SPS/CG Type 2 release when 2 codewords per SPS/UL grant Type 2 configuration and multiple SPS/UL grant Type 2 configurations are provided.

Table 5: Special Fields for a Single or Multiple DL SPS and UL Grant Type 2 Scheduling Release PDCCH Validation when a UE is Provided Multiple DL SPS or UL Grant

Type 2 configurations in the active DL/UL BWP of the scheduled cell

| | DCI format | DCI format | DCI format | DCI format |
|---|---|---|---|---|
| | 0_0 | 1_0 | 0_1/0_2 | 1_1/1_2 |
| Redundancy version for | set to all ‘0’s | set to all ‘0’s | set to all ‘0’s | set to all ‘0’s |
| first TB | | | | |
| Redundancy version for | N/A | N/A | set to all ‘0’s | set to all ‘0’s |
| second TB | | | | |
| Modulation and coding | set to all ‘1’s | set to all ‘1’s | set to all ‘1’s | set to all ‘1’s |
| scheme | | | | |
| Frequency domain | set to all ‘0’s for | set to all ‘0’s for | set to all ‘0’s for | set to all ‘0’s for |
| resource assignment | FDRA Type 2 | FDRA Type 0 or for | FDRA Type 2 | FDRA Type 0 or for |
| | with μ = 1 | dynamicSwitch | with μ = 1 | dynamicSwitch |
| | set to all ‘1’s, | set to all ‘1’s for | set to all ‘1’s, | set to all ‘1’s for |
| | otherwise | FDRA Type 1 | otherwise | FDRA Type 1 |

In some embodiments, multiple codeword transmission (or more than a predetermined number of layers e.g. 4 layers) on SPS PDSCH may be an optional feature in the UE, and network may be notified by the UE with the UE capability on the support of multiple codewords on SPS PDSCH by the UE. This makes it possible for the network to know whether a multiple codeword transmission on SPS PDSCH can be enabled or not for a specific UE based on the UE capability reported.

In some embodiments, a UE may report the capability of supporting multiple codeword transmission (or more than a predetermined number of layers e.g. 4 layers) on SPS PDSCH after RRC connection. In some embodiments, the capability of supporting multiple codeword transmission (or more than a predetermined number of layers e.g. 4 layers) on SPS PDSCH and DG PDSCH may be separately reported. Once the gNB received the capability report, the gNB may configure the UE with the maximum number of codewords for SPS PDSCH that the UE should expect from the gNB. This configuration may be performed via an RRC configured from the gNB to the UE.

In some embodiments, UE capability of supporting multiple codeword transmission (or more than a predetermined number of layers e.g. 4 layers) on SPS PDSCH scheduled by DCI 1-2 or a new DCI format different from DCI format 1-0/1-1/1-2 may be separately reported.

With the above embodiments, transmission with multiple codewords may be achieved between a UE and a gNB, such that a higher throughput, a higher reliability, and a faster response for the uplink transmission may be achieved.

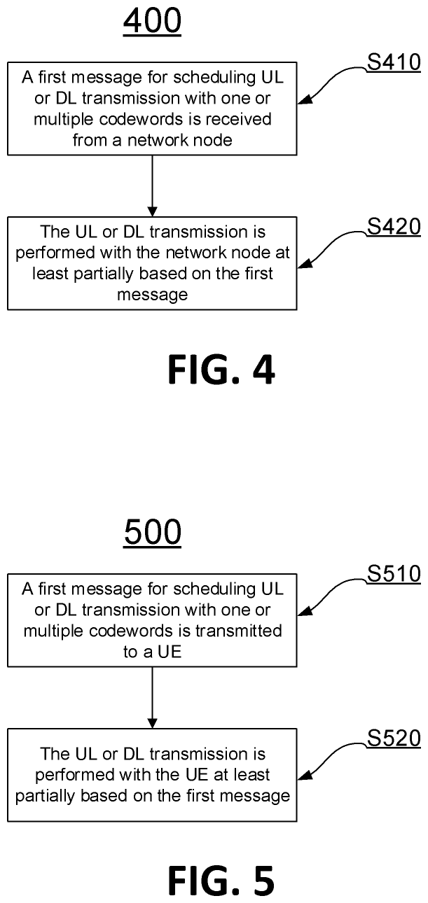

FIG. 4 is a flow chart of an exemplary method 400 at a UE for transmission with multiple codewords according to an embodiment of the present disclosure. The method 400 may be performed at a user equipment (e.g., the UE 700 shown in FIG. 7). The method 400 may comprise steps S410 and S420. However, the present disclosure is not limited thereto. In some other embodiments, the method 400 may comprise more steps, different steps, or any combination thereof. Further the steps of the method 400 may be performed in a different order than that described herein when multiple steps are involved. Further, in some embodiments, a step in the method 400 may be split into multiple sub-steps and performed by different entities, and/or multiple steps in the method 400 may be combined into a single step.

The method 400 may begin at step S410 where a first message for scheduling UL or DL transmission with one or multiple codewords may be received from a network node.

At step S420, the UL or DL transmission may be performed with the network node at least partially based on the first message.

In some embodiments, the DL transmission may be a first DL SPS transmission. In some embodiments, a first maximum number of the codewords that can be carried by the DL transmission may be configured to the UE, wherein the first maximum number may be greater than 1. In some embodiments, the first message may be an RRC message for semi-persistently scheduling the DL transmission and indicating a first number of the codewords to be carried by the DL transmission, wherein the first number may be less than or equal to the first maximum number. In some embodiments, a first number of the codewords to be carried by the DL transmission may be assumed by the UE to be equal to the first maximum number. In some embodiments, when the first number is greater than 1, the method 400 may further comprise: receiving, from the network node, a second message indicating at least one of the codewords is enabled or disabled. In some embodiments, the second message may be a DCI message. In some embodiments, the second message may comprise one or more fields that have one or more specific values or a specific combination of specific values, the one or more specific values or the specific combination of specific values indicating that the at least one codeword may be enabled or disabled.

In some embodiments, a first number of the codewords to be carried by the DL transmission may be assumed by the UE to be same as the first maximum number and no codeword is to be disabled. In some embodiments, the UE may be configured with multiple DL SPS configurations comprising a first DL SPS configuration corresponding to the first DL SPS transmission, wherein whether at least one of multiple DL SPS transmissions corresponding to the multiple DL SPS configurations shall carry multiple codewords may be configured independently of whether another of the multiple DL SPS transmissions shall carry multiple codewords. In some embodiments, the first DL SPS transmission may be configured with multiple codewords, wherein when the first DL SPS transmission is activated by a DCI message of a first format, one or more of the multiple codewords may be enabled. In some embodiments, the first DL SPS transmission may be configured with multiple codewords, wherein when the first DL SPS transmission is activated by a DCI message of a second format, only one of the multiple codewords may be enabled.

In some embodiments, the first format may be DCI format 1_1, and the second format may be DCI format 1_0 or 1_2. In some embodiments, the first DL SPS transmission may be configured with multiple codewords, and the method 400 may further comprise: transmitting, to the network node, a third message comprising one or more indicators for acknowledging or negatively acknowledging at least two of the multiple codewords. In some embodiments, the step of transmitting, to the network node, the third message may comprise: transmitting, to the network node, the third message comprising one or more indicators for acknowledging or negatively acknowledging the multiple codewords. In some embodiments, the indicators may be HARQ-ACK bits. In some embodiments, at least one indicator may be a bundled indicator that acknowledges or negatively acknowledges two or more codewords. In some embodiments, a bundled indicator may acknowledge or negatively acknowledge two or more codewords by performing a logical AND operation on HARQ-ACK bits for the two or more codewords when a HARQ-ACK bit of 1 indicates a successfully decoded codeword while a HARQ-ACK bit of 0 indicates an unsuccessfully decoded codeword. In some embodiments, the method 400 may further comprise: receiving, from the network node, a configuration indicating whether the indicators in the third message shall be bundled indicators or not. In some embodiments, the configuration may be a first IE when the third message is a PUSCH message, wherein the configuration may be a second IE that is different from the first IE when the third message is a PUCCH message. In some embodiments, the first IE may be SPS-harq-ACK-SpatiaBundlingPUSCH, and the second IE may be SPS-harq-ACK-SpatialBundlingPUCCH.

In some embodiments, the DL transmission may be a first DL transmission. In some embodiments, the first DL transmission may be scheduled, activated, or released by a DCI message that may have a different format than DCI format 1_1 and support the multiple codewords. In some embodiments, the DCI message may be a DCI format 1_2 message or a DCI message of a format other than DCI formats 1_0, 1_1, and 1_2. In some embodiments, a second maximum number of the codewords that can be scheduled by the DCI message may be configured to the UE. In some embodiments, the second maximum number may be configured by a maxNrofCodeWordsScheduledByDCI-1-2 IE in a PDSCH-Config IE that may be configured to the UE by the network node. In some embodiments, at least one of the following fields may be configured to the UE for each of at least two of the multiple codewords: —MCS; —NDI; and —RV.

In some embodiments, the DL or UL transmission may be a first DL SPS transmission or a first UL Type-2 CG transmission, respectively. In some embodiments, the method 400 may further comprise: receiving, from the network node, a fourth message; and validating the fourth message for scheduling activation or scheduling release. In some embodiments, the fourth message may be a DCI message. In some embodiments, the step of validating the fourth message may comprise: checking whether at least one field of the fourth message is set according to a predefined criterion or not. In some embodiments, the at least one field may comprise at least one of: —HARQ process number; —one or more RVs for one or more codewords; —one or more MCSs for one or more codewords; and —an FDRA type.

In some embodiments, when a single DL SPS is configured to the UE and when the DL transmission is the DL SPS transmission corresponding to the single DL SPS, the fourth message may be validated for scheduling activation when at least one field of the fourth message is set as at least one entry of the following table:

| | DCI format 1_0 | DCI format 1_1/1_2 |
|---|---|---|
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |

In some embodiments, when a single UL Type-2 CG is configured to the UE and when the UL transmission is the UL Type-2 CG transmission corresponding to the single UL Type-2 CG, the fourth message may be validated for scheduling activation when at least one field of the fourth message is set as at least one entry of the following table:

| | DCI format 0_0 | DCI format 0_1/0_2 |
|---|---|---|
| HARQ process number | set to all ‘0’s | set to all ‘0’s |
| Redundancy version for | set to all ‘0’s | set to all ‘0’s |
| first TB | | |
| Redundancy version for | N/A | set to all ‘0’s |
| second TB | | |

In some embodiments, when a single DL SPS is configured to the UE and when the DL transmission is the DL SPS transmission corresponding to the single DL SPS, the fourth message may be validated for scheduling release when at least one field of the fourth message is set as at least one entry of the following table:

| | DCI format 1_0 | DCI format 1_1/1_2 |
|---|---|---|
| HARQ process number | set to all ‘0’s | set to all ‘0’s |
| Redundancy version for first TB | set to all ‘0’s | set to all ‘0’s |
| Redundancy version for second | N/A | set to all ‘0’s |
| TB | | |
| Modulation and coding scheme | set to all ‘1’s | set to all ‘1’s |
| for first TB | | |
| Modulation and coding scheme | N/A | set to all ‘1’s |
| for second TB | | |
| Frequency domain resource | set to all ‘0’s for FDRA Type 0 or for | set to all ‘0’s for FDRA Type 0 or for |
| assignment | dynamicSwitch | dynamicSwitch |
| | set to all ‘1’s for FDRA Type 1 | set to all ‘1’s for FDRA Type 1 |

In some embodiments, when a single UL Type-2 CG is configured to the UE and when the UL transmission is the UL Type-2 CG transmission corresponding to the single UL Type-2 CG, the fourth message may be validated for scheduling release when at least one field of the fourth message is set as at least one entry of the following table:

| | DCI format 0_0 | DCI format 0_1/0_2 |
|---|---|---|
| HARQ process number | set to all ‘0’s | set to all ‘0’s |
| Redundancy version for first TB | set to all ‘0’s | set to all ‘0’s |
| Redundancy version for second TB | N/A | set to all ‘0’s |
| Modulation and coding scheme for | set to all ‘1’s | set to all ‘1’s |
| first TB | | |
| Modulation and coding scheme for | N/A | set to all ‘1’s |
| second TB | | |
| Frequency domain resource | set to all ‘0’s for FDRA Type 2 | set to all ‘0’s for FDRA Type 2 |
| assignment | with μ = 1 | with μ = 1 |
| | set to all ‘1’s, otherwise | set to all ‘1’s, otherwise |

In some embodiments, when multiple DL SPSs are configured to the UE and when the DL transmission is one of multiple DL SPS transmissions corresponding to the multiple DL SPSs, and when a HARQ process number field in the fourth message has a same value as that of an sps-ConfigIndex IE configured for the first DL SPS transmission, the fourth message may be validated for scheduling activation when at least one field of the fourth message is set as at least one entry of the following table:

| | DCI format 1_0 | DCI format 1_1/1_2 |
|---|---|---|
| Redundancy version | set to all ‘0’s | set to all ‘0’s |
| for first TB | | |
| Redundancy version | N/A | set to all ‘0’s |
| for second TB | | |

In some embodiments, when multiple UL Type-2 CGs are configured to the UE and when the UL transmission is one of multiple UL Type-2 CG transmissions corresponding to the multiple UL Type-2 CGs, and when a HARQ process number field in the fourth message has a same value as that of a ConfiguredGrantConfigIndex IE configured for the first UL Type-2 CG transmission, the fourth message may be validated for scheduling activation when at least one field of the fourth message is set as at least one entry of the following table:

| | DCI format 0_0 | DCI format 0_1/0_2 |
|---|---|---|
| Redundancy version | set to all ‘0’s | set to all ‘0’s |
| for first TB | | |
| Redundancy version | N/A | set to all ‘0’s |
| for second TB | | |

In some embodiments, when multiple DL SPSs are configured to the UE and when the DL transmission is one of multiple DL SPS transmissions corresponding to the multiple DL SPSs, when a HARQ process number field in the fourth message has a same value as that of an sps-ConfigIndex IE configured for the first DL SPS transmission, the fourth message may be validated for scheduling release when at least one field of the fourth message is set as at least one entry of the following table:

| | DCI format 1_0 | DCI format 1_1/1_2 |
|---|---|---|
| Redundancy version for first | set to all ‘0’s | set to all ‘0’s |
| TB | | |
| Redundancy version for | N/A | set to all ‘0’s |
| second TB | | |
| Modulation and coding | set to all ‘1’s | set to all ‘1’s |
| scheme | | |
| Frequency domain resource | set to all ‘0’s for FDRA Type 0 or for | set to all ‘0’s for FDRA Type 0 or for |
| assignment | dynamicSwitch | dynamicSwitch |
| | set to all ‘1’s for FDRA Type 1 | set to all ‘1’s for FDRA Type 1 |

In some embodiments, when multiple UL Type-2 CGs are configured to the UE and when the UL transmission is one of multiple UL Type-2 CG transmissions corresponding to the multiple UL Type-2 CGs, when a HARQ process number field in the fourth message has a same value as that of a ConfiguredGrantConfigIndex IE configured for the first UL Type-2 CG transmission, the fourth message may be validated for scheduling release when at least one field of the fourth message is set as at least one entry of the following table:

| | DCI format 0_0 | DCI format 0_1/0_2 |
|---|---|---|
| Redundancy version for first TB | set to all ‘0’s | set to all ‘0’s |
| Redundancy version for second TB | N/A | set to all ‘0’s |
| Modulation and coding scheme | set to all ‘1’s | set to all ‘1’s |
| Frequency domain resource | set to all ‘0’s for FDRA Type 2 with | set to all ‘0’s for FDRA Type 2 with |
| assignment | μ = 1 | μ = 1 |
| | set to all ‘1’s, otherwise | set to all ‘1’s, otherwise |

In some embodiments, the method 400 may further comprise: transmitting, to the network node, a fifth message indicating whether DL transmission with multiple codewords and/or with more than 4 layers is supported by the UE or not. In some embodiments, the fifth message may indicate at least one of: —whether DL SPS transmission with multiple codewords and/or with more than 4 layers is supported by the UE or not; and —whether DG based DL transmission with multiple codewords and/or with more than 4 layers is supported by the UE or not. In some embodiments, whether DL SPS transmission with multiple codewords and/or with more than 4 layers is supported by the UE or not may be indicated by a third IE, wherein whether DG based DL transmission with multiple codewords and/or with more than 4 layers is supported by the UE or not may be indicated by a fourth IE that is different from the third IE.

In some embodiments, the fifth message may be transmitted when the UE is in the connected state. In some embodiments, the fifth message may further indicate whether the DL transmission with multiple codewords and/or with more than 4 layers can be scheduled by a DCI message of a specific format. In some embodiments, the specific format may be DCI format 1_2 or another DCI format than DCI formats 1_0, 1_1, and 1_2. In some embodiments, the UL or DL transmission may be PDSCH transmission or PUSCH transmission. In some embodiments, the network node may comprise a TRP.

FIG. 5 is a flow chart of an exemplary method 500 at a network node for transmission with multiple codewords according to an embodiment of the present disclosure. The method 500 may be performed at a network node (e.g., the network node 800 shown in FIG. 8). The method 500 may comprise steps S510 and S520. However, the present disclosure is not limited thereto. In some other embodiments, the method 500 may comprise more steps, different steps, or any combination thereof. Further the steps of the method 500 may be performed in a different order than that described herein when multiple steps are involved. Further, in some embodiments, a step in the method 500 may be split into multiple sub-steps and performed by different entities, and/or multiple steps in the method 500 may be combined into a single step.

The method 500 may begin at step S510 where a first message for scheduling UL or DL transmission with one or multiple codewords may be transmitted to a UE.

At step S520 the UL or DL transmission may be performed with the UE at least partially based on the first message.

In some embodiments, the DL transmission may be a first DL SPS transmission.

In some embodiments, a first maximum number of the codewords that can be carried by the DL transmission may be configured to the UE, wherein the first maximum number may be greater than 1. In some embodiments, the first message may be an RRC message for semi-persistently scheduling the DL transmission and indicating a first number of the codewords to be carried by the DL transmission, wherein the first number may be less than or equal to the first maximum number. In some embodiments, a first number of the codewords to be carried by the DL transmission may be assumed by the network node to be equal to the first maximum number. In some embodiments, when the first number is greater than 1, the method 500 may further comprise: transmitting, to the UE, a second message indicating at least one of the codewords is enabled or disabled. In some embodiments, the second message may be a DCI message. In some embodiments, the second message may comprise one or more fields that have one or more specific values or a specific combination of specific values, the one or more specific values or the specific combination of specific values indicating that the at least one codeword may be enabled or disabled.

In some embodiments, a first number of the codewords to be carried by the DL transmission may be assumed by the network to be same as the first maximum number and no codeword is to be disabled. In some embodiments, the UE may be configured by the network node with multiple DL SPS configurations comprising a first DL SPS configuration corresponding to the first DL SPS transmission, wherein whether at least one of multiple DL SPS transmissions corresponding to the multiple DL SPS configurations shall carry multiple codewords may be configured independently of whether another of the multiple DL SPS transmissions shall carry multiple codewords.

In some embodiments, the first DL SPS transmission may be configured with multiple codewords, wherein when the first DL SPS transmission is activated by a DCI message of a first format, one or more of the multiple codewords may be enabled. In some embodiments, the first DL SPS transmission may be configured with multiple codewords, wherein when the first DL SPS transmission is activated by a DCI message of a second format, only one of the multiple codewords may be enabled. In some embodiments, the first format may be DCI format 1_1, and the second format may be DCI format 1_0 or 1_2. In some embodiments, the first DL SPS transmission may be configured with multiple codewords, and the method 500 may further comprise: receiving, from the UE, a third message comprising one or more indicators for acknowledging or negatively acknowledging at least two of the multiple codewords. In some embodiments, the step of receiving, from the UE, the third message may comprise: receiving, from the UE, the third message comprising one or more indicators for acknowledging or negatively acknowledging the multiple codewords.

In some embodiments, the indicators may be HARQ-ACK bits. In some embodiments, at least one indicator may be a bundled indicator that acknowledges or negatively acknowledges two or more codewords. In some embodiments, a bundled indicator may acknowledge or negatively acknowledge two or more codewords by performing a logical AND operation on HARQ-ACK bits for the two or more codewords when a HARQ-ACK bit of 1 indicates a successfully decoded codeword while a HARQ-ACK bit of 0 indicates an unsuccessfully decoded codeword. In some embodiments, the method 500 may further comprise: transmitting, to the UE, a configuration indicating whether the indicators in the third message shall be bundled indicators or not. In some embodiments, the configuration may be a first IE when the third message is a PUSCH message, wherein the configuration may be a second IE that is different from the first IE when the third message is a PUCCH message. In some embodiments, the first IE may be SPS-harq-ACK-SpatialBundlingPUSCH, and the second IE may be SPS-harq-ACK-SpatialBundlingPUCCH. In some embodiments, the DL transmission may be a first DL transmission. In some embodiments, the first DL transmission may be scheduled, activated, or released by a DCI message that has a different format than DCI format 1_1 and supports the multiple codewords. In some embodiments, the DCI message may be a DCI format 1_2 message or a DCI message of a format other than DCI formats 1_0, 1_1, and 1_2.

In some embodiments, a second maximum number of the codewords that can be scheduled by the DCI message may be configured to the UE by the network node. In some embodiments, the second maximum number may be configured by a maxNrofCodeWordsScheduledByDCI-1-2 IE in a PDSCH-Config IE that may be configured to the UE by the network node. In some embodiments, at least one of the following fields may be configured to the UE by the network node for each of at least two of the multiple codewords: —MCS; —NDI; and —RV. In some embodiments, the DL or UL transmission may be a first DL SPS transmission or a first UL Type-2 CG transmission, respectively. In some embodiments, the method 500 may further comprise: generating a fourth message for activating or releasing the transmission; and transmitting, to the UE, the fourth message. In some embodiments, the fourth message may a DCI message. In some embodiments, the step of generating the fourth message may comprise: setting at least one field of the fourth message according to a predefined criterion associated with scheduling activation or scheduling release. In some embodiments, the at least one field may comprise at least one of: —HARQ process number; —one or more RVs for one or more codewords; —one or more MCSs for one or more codewords; and —an FDRA type.

In some embodiments, when a single DL SPS is configured to the UE and when the DL transmission is the DL SPS transmission corresponding to the single DL SPS, and when the fourth message is generated for scheduling activation, the at least one field of the fourth message may be set as at least one entry of the following table:

| | DCI format 1_0 | DCI format 1_1/1_2 |
|---|---|---|
| HARQ process number | set to all ‘0’s | set to all ‘0’s |
| Redundancy version | set to all ‘0’s | set to all ‘0’s |
| for first TB | | |
| Redundancy version | N/A | set to all ‘0’s |
| for second TB | | |

In some embodiments, when a single UL Type-2 CG is configured to the UE and when the UL transmission is the UL Type-2 CG transmission corresponding to the single UL Type-2 CG, and when the fourth message is generated for scheduling activation, the at least one field of the fourth message may be set as at least one entry of the following table:

| | DCI format 0_0 | DCI format 0_1/0_2 |
|---|---|---|
| HARQ process number | set to all ‘0’s | set to all ‘0’s |
| Redundancy version | set to all ‘0’s | set to all ‘0’s |
| for first TB | | |
| Redundancy version | N/A | set to all ‘0’s |
| for second TB | | |

In some embodiments, when a single DL SPS is configured to the UE and when the DL transmission is the DL SPS transmission corresponding to the single DL SPS, and when the fourth message is generated for scheduling release, the at least one field of the fourth message may be set as at least one entry of the following table:

| | DCI format 1_0 | DCI format 1_1/1_2 |
|---|---|---|
| HARQ process number | set to all ‘0’s | set to all ‘0’s |
| Redundancy version for first TB | set to all ‘0’s | set to all ‘0’s |
| Redundancy version for second | N/A | set to all ‘0’s |
| TB | | |
| Modulation and coding scheme | set to all ‘1’s | set to all ‘1’s |
| for first TB | | |
| Modulation and coding scheme | N/A | set to all ‘1’s |
| for second TB | | |
| Frequency domain resource | set to all ‘0’s for FDRA Type 0 or for | set to all ‘0’s for FDRA Type 0 or for |
| assignment | dynamicSwitch | dynamicSwitch |
| | set to all ‘1’s for FDRA Type 1 | set to all ‘1’s for FDRA Type 1 |

In some embodiments, when a single UL Type-2 CG is configured to the UE and when the UL transmission is the UL Type-2 CG transmission corresponding to the single UL Type-2 CG, and when the fourth message is generated for scheduling release, the at least one field of the fourth message may be set as at least one entry of the following table:

| | DCI format 0_0 | DCI format 0_1/0_2 |
|---|---|---|
| HARQ process number | set to all ‘0’s | set to all ‘0’s |
| Redundancy version for first TB | set to all ‘0’s | set to all ‘0’s |
| Redundancy version for second TB | N/A | set to all ‘0’s |
| Modulation and coding scheme for | set to all ‘1’s | set to all ‘1’s |
| first TB | | |
| Modulation and coding scheme for | N/A | set to all ‘1’s |
| second TB | | |
| Frequency domain resource | set to all ‘0’s for FDRA Type 2 | set to all ‘0’s for FDRA Type 2 |
| assignment | with μ = 1 | with μ = 1 |
| | set to all ‘1’s, otherwise | set to all ‘1’s, otherwise |

In some embodiments, when multiple DL SPSs are configured to the UE and when the DL transmission is one of multiple DL SPS transmissions corresponding to the multiple DL SPSs, and when the fourth message is generated for scheduling activation, a HARQ process number field in the fourth message may be set as a value of an sps-ConfigIndex IE configured for the first DL SPS transmission and the at least one field of the fourth message may be set as at least one entry of the following table:

| | DCI format 1_0 | DCI format 1_1/1_2 |
|---|---|---|
| Redundancy version | set to all ‘0’s | set to all ‘0’s |
| for first TB | | |
| Redundancy version | N/A | set to all ‘0’s |
| for second TB | | |

In some embodiments, when multiple UL Type-2 CGs are configured to the UE and when the UL transmission is one of multiple UL Type-2 CG transmissions corresponding to the multiple UL Type-2 CGs, and when the fourth message is generated for scheduling activation, a HARQ process number field in the fourth message may be set as a value of a ConfiguredGrantConfigIndex IE configured for the first UL Type-2 CG transmission, and the at least one field of the fourth message may be set as at least one entry of the following table:

| | DCI format 0_0 | DCI format 0_1/0_2 |
|---|---|---|
| Redundancy version | set to all ‘0’s | set to all ‘0’s |
| for first TB | | |
| Redundancy version | N/A | set to all ‘0’s |
| for second TB | | |

In some embodiments, when multiple DL SPSs are configured to the UE and when the DL transmission is one of multiple DL SPS transmissions corresponding to the multiple DL SPSs, and when the fourth message is generated for scheduling release, a HARQ process number field in the fourth message may be set as a value of an sps-ConfigIndex IE configured for the first DL SPS transmission, and the at least one field of the fourth message may be set as at least one entry of the following table:

| | DCI format 1_0 | DCI format 1_1/1_2 |
|---|---|---|
| Redundancy version for first | set to all ‘0’s | set to all ‘0’s |
| TB | | |
| Redundancy version for | N/A | set to all ‘0’s |
| second TB | | |
| Modulation and coding | set to all ‘1’s | set to all ‘1’s |
| scheme | | |
| Frequency domain resource | set to all ‘0’s for FDRA Type 0 or for | set to all ‘0’s for FDRA Type 0 or for |
| assignment | dynamicSwitch | dynamicSwitch |
| | set to all ‘1’s for FDRA Type 1 | set to all ‘1’s for FDRA Type 1 |

In some embodiments, when multiple UL Type-2 CGs are configured to the UE and when the UL transmission is one of multiple UL Type-2 CG transmissions corresponding to the multiple UL Type-2 CGs, when the fourth message is generated for scheduling release, a HARQ process number field in the fourth message may be set as a value of a ConfiguredGrantConfigIndex IE configured for the first UL Type-2 CG transmission, when at least one field of the fourth message may be set as at least one entry of the following table:

| | DCI format 0_0 | DCI format 0_1/0_2 |
|---|---|---|
| Redundancy version for first TB | set to all ‘0’s | set to all ‘0’s |
| Redundancy version for second TB | N/A | set to all ‘0’s |
| Modulation and coding scheme | set to all ‘1’s | set to all ‘1’s |
| Frequency domain resource | set to all ‘0’s for FDRA Type 2 with | set to all ‘0’s for FDRA Type 2 with |
| assignment | μ = 1 | μ = 1 |
| | set to all ‘1’s, otherwise | set to all ‘1’s, otherwise |

In some embodiments, the method 500 may further comprise: receiving, from the UE, a fifth message indicating whether DL transmission with multiple codewords and/or with more than 4 layers is supported by the UE or not. In some embodiments, the fifth message may indicate at least one of: —whether DL SPS transmission with multiple codewords and/or with more than 4 layers is supported by the UE or not; and —whether DG based DL transmission with multiple codewords and/or with more than 4 layers is supported by the UE or not. In some embodiments, whether DL SPS transmission with multiple codewords and/or with more than 4 layers is supported by the UE or not may be indicated by a third IE, wherein whether DG based DL transmission with multiple codewords and/or with more than 4 layers is supported by the UE or not may be indicated by a fourth IE that is different from the third IE. In some embodiments, the fifth message may be received when the UE is in the connected state.

In some embodiments, the fifth message may further indicate whether the DL transmission with multiple codewords and/or with more than 4 layers can be scheduled by a DCI message of a specific format. In some embodiments, the specific format may be DCI format 1_2 or another DCI format than DCI formats 1_0, 1_1, and 1_2. In some embodiments, the UL or DL transmission may be PDSCH transmission or PUSCH transmission. In some embodiments, the network node may comprise a TRP.

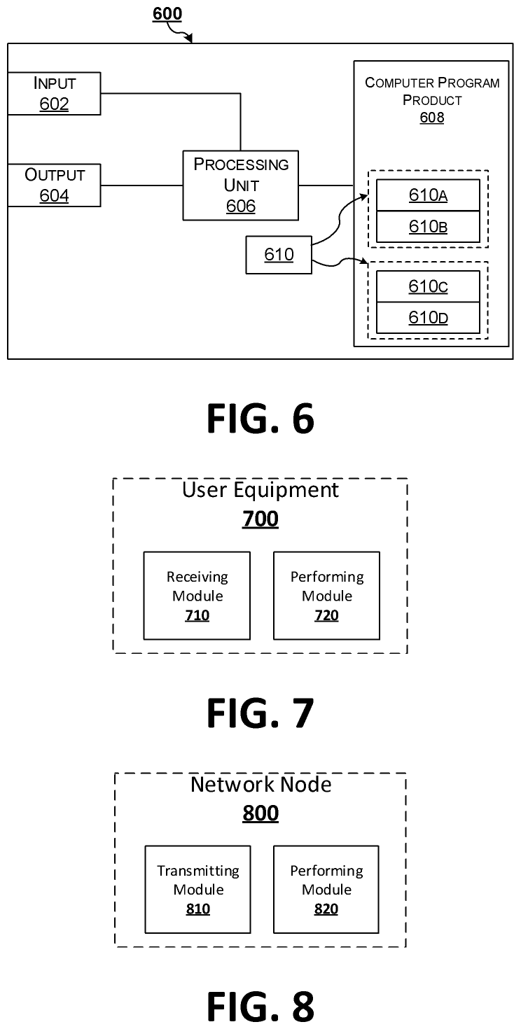

FIG. 6 schematically shows an embodiment of an arrangement 600 which may be used in a user equipment (e.g., the UE 700) or a network node (e.g., the network node 800) according to an embodiment of the present disclosure. Comprised in the arrangement 600 are a processing unit 606, e.g., with a Digital Signal Processor (DSP) or a Central Processing Unit (CPU). The processing unit 606 may be a single unit or a plurality of units to perform different actions of procedures described herein. The arrangement 600 may also comprise an input unit 602 for receiving signals from other entities, and an output unit 604 for providing signal(s) to other entities. The input unit 602 and the output unit 604 may be arranged as an integrated entity or as separate entities.

Furthermore, the arrangement 600 may comprise at least one computer program product 608 in the form of a non-volatile or volatile memory, e.g., an Electrically Erasable Programmable Read-Only Memory (EEPROM), a flash memory and/or a hard drive. The computer program product 608 comprises a computer program 610, which comprises code/computer readable instructions, which when executed by the processing unit 606 in the arrangement 600 causes the arrangement 600 and/or the UE/network node in which it is comprised to perform the actions, e.g., of the procedure described earlier in conjunction with FIG. 4 to FIG. 5 or any other variant.

The computer program 610 may be configured as a computer program code structured in computer program modules 610A and 610B. Hence, in an exemplifying embodiment when the arrangement 600 is used in a UE, the code in the computer program of the arrangement 600 includes: a module 610A for receiving, from a network node, a first message for scheduling UL or DL transmission with one or multiple codewords and a module 610B for performing, with the network node, the UL or DL transmission at least partially based on the first message.

Further, the computer program 610 may be further configured as a computer program code structured in computer program modules 610C and 610D. Hence, in an exemplifying embodiment when the arrangement 600 is used in a network node, the code in the computer program of the arrangement 600 includes: a module 610C for transmitting, to a UE, a first message for scheduling UL or DL transmission with one or multiple codewords; and a module 610D for performing, with the UE, the UL or DL transmission at least partially based on the first message.

The computer program modules could essentially perform the actions of the flow illustrated in FIG. 4 to FIG. 5, to emulate the UE or the network node. In other words, when the different computer program modules are executed in the processing unit 606, they may correspond to different modules in the UE or the network node.

Although the code means in the embodiments disclosed above in conjunction with FIG. 6 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

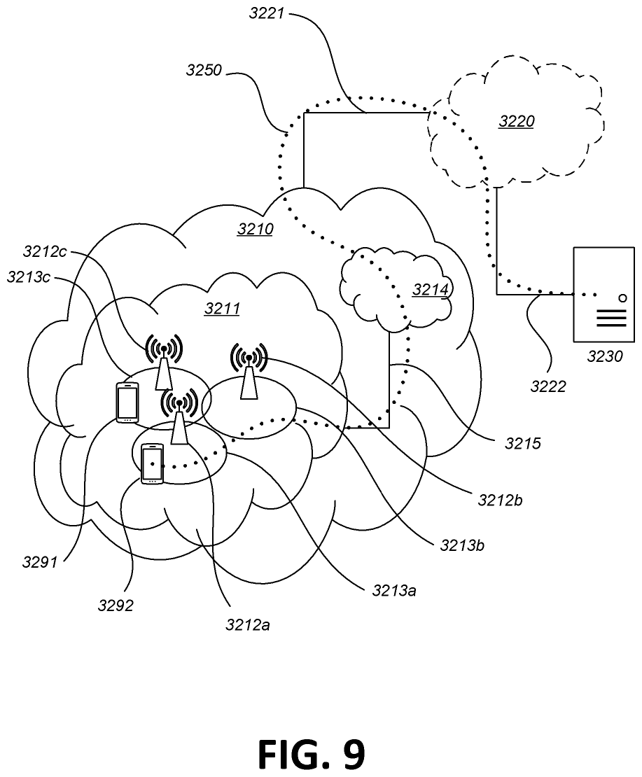

Correspondingly to the method 400 as described above, an exemplary user equipment is provided. FIG. 7 is a block diagram of a UE 700 according to an embodiment of the present disclosure. The UE 700 may be, e.g., the UE 3291 or 3292 shown in FIG. 9.

The UE 700 may be configured to perform the method 400 as described above in connection with FIG. 4. As shown in FIG. 7, the UE 700 may comprise a receiving module 710 for receiving, from a network node, a first message for scheduling UL or DL transmission with one or multiple codewords; and a performing module 720 for performing, with the network node, the UL or DL transmission at least partially based on the first message.

The above modules 710 and 720 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4. Further, the UE 700 may comprise one or more further modules, each of which may perform any of the steps of the method 400 described with reference to FIG. 4.

Correspondingly to the method 500 as described above, a network node is provided. FIG. 8 is a block diagram of an exemplary network node 800 according to an embodiment of the present disclosure. The network node 800 may be, e.g., the base station 3212a, 3212b, or 3212c shown in FIG. 9.

The network node 800 may be configured to perform the method 500 as described above in connection with FIG. 5. As shown in FIG. 8, the network node 800 may comprise a transmitting module 810 for transmitting, to a UE, a first message for scheduling UL or DL transmission with one or multiple codewords; and a performing module 820 for performing, with the UE, the UL or DL transmission at least partially based on the first message.

The above modules 810 and 820 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the network node 800 may comprise one or more further modules, each of which may perform any of the steps of the method 500 described with reference to FIG. 5.

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

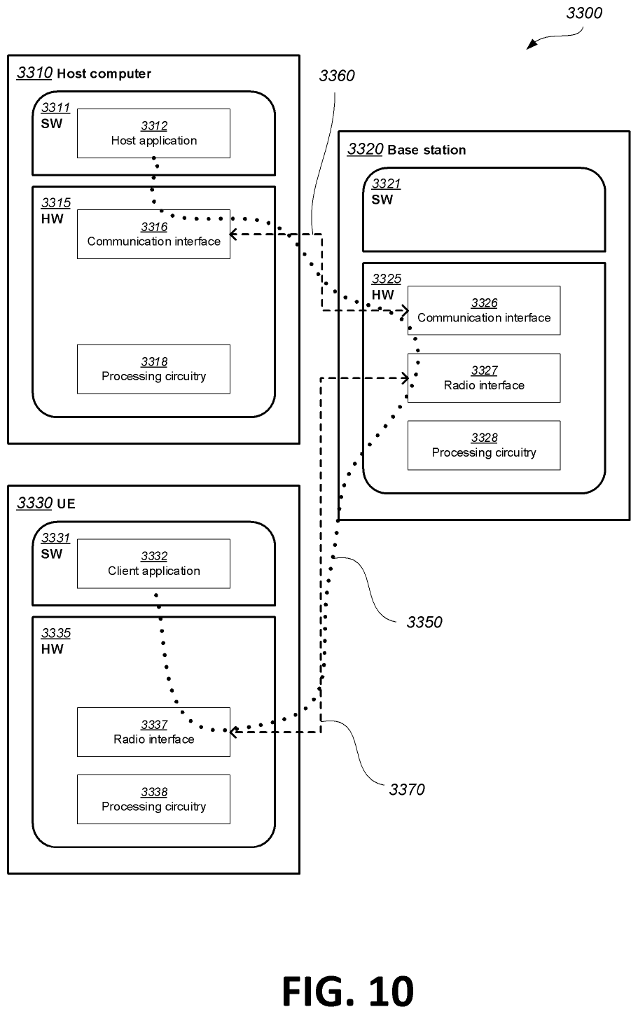

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

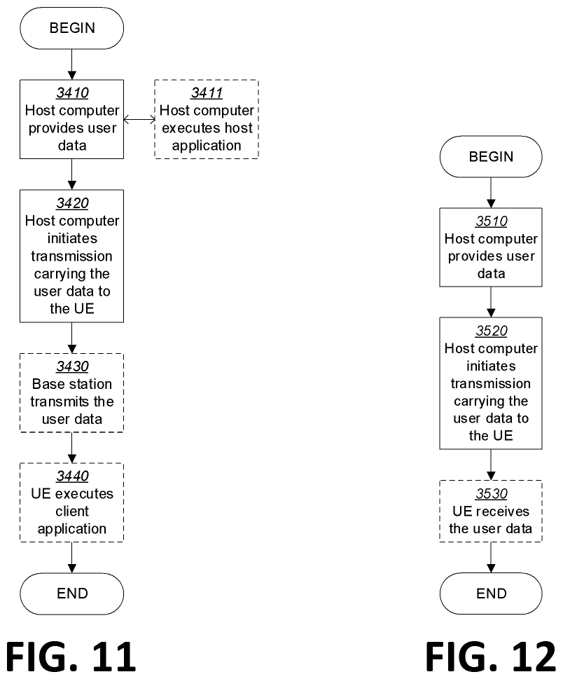

FIG. 11 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

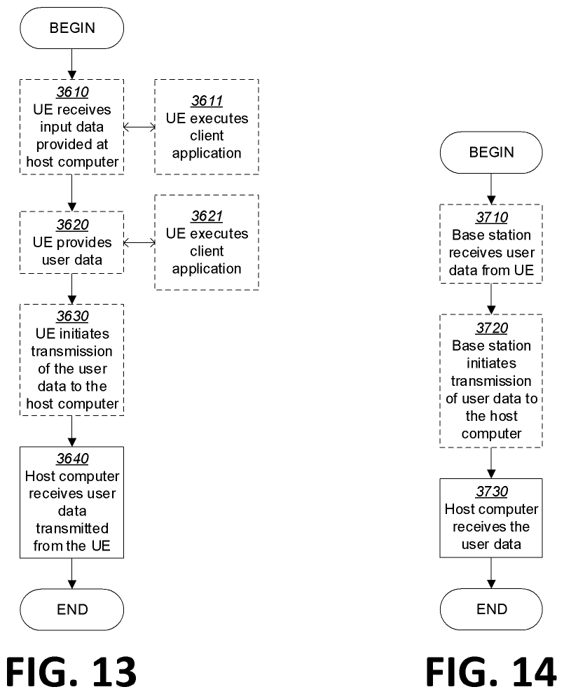

FIG. 13 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BS | Base station |
| CB | Code Block |
| CBG | Code Block Group |
| CBGTI | Code Block Group Transmission Information |
| CG | Configured Grant |
| CRC | Cyclic Redundancy Check |
| CRM | Contention Resolution Message |
| CSI | Channel State Information |
| DCI | Downlink Control Information |
| DG | Dynamic Grant |
| DL | Downlink |
| DM-RS | Demodulation Reference Signal |
| eMTC | Enhanced Machine Type Communication |
| FH | Frequency Hopping |
| FR1 | Frequency Range 1 |
| FR2 | Frequency Range 2 |
| gNB | Network Node in NR |
| HARQ | Hybrid Automated Retransmission Request |
| MAC | Medium Access Control |
| Msg3 | Message 3 |
| NB-IoT | Narrow-Band Internet of Things |
| NR | New Radio |
| PDCCH | Physical Downlink Control Channel |
| PUSCH | Physical Uplink Shared Data Channel |
| PRB | Physical Resource Block, i.e., 12 consecutive subcarriers |
| RE | Resource Element |
| RNTI | Radio Network Temporary Identifier |
| RSRP | Reference Signal Received Power |
| RV | Redundancy Version |
| SPS | Semi-Persistent Scheduling |
| TB | Transport Block |
| TBS | TB Size |
| TxD | Transmit Diversity |
| UE | User Equipment |
| UL | Uplink |

1. A method at a user equipment (UE) for uplink (UL) or downlink (DL) transmission, the method comprising:
receiving, from a network node, a first message for scheduling UL or DL transmission with one or multiple codewords; and
performing, with the network node, the UL or DL transmission at least partially based on the first message.

2. The method of claim 1, wherein the DL transmission is a first downlink (DL) semi-persistent scheduling (SPS) transmission.

3. The method of claim 1, wherein a first maximum number of the codewords that can be carried by the DL transmission is configured to the UE,
wherein the first maximum number is greater than 1.

4. The method of claim 1, wherein the first message is an RRC message for semi-persistently scheduling the DL transmission and indicating a first number of the codewords to be carried by the DL transmission,
wherein the first number is less than or equal to the first maximum number.

5. The method of claim 1, wherein a first number of the codewords to be carried by the DL transmission is assumed by the UE to be equal to the first maximum number.

6. The method of claim 1, wherein when the first number is greater than 1, the method further comprises:
receiving, from the network node, a second message indicating at least one of the codewords is enabled or disabled.

7. The method of claim 6, wherein the second message is a Downlink Control information (DCI) message.

8. The method of claim 6, wherein the second message comprises one or more fields that have one or more specific values or a specific combination of specific values, the one or more specific values or the specific combination of specific values indicating that the at least one codeword is enabled or disabled.

9. The method of claim 1, wherein a first number of the codewords to be carried by the DL transmission is assumed by the UE to be same as the first maximum number and no codeword is to be disabled.

10. The method of claim 2, wherein the UE is configured with multiple DL SPS configurations comprising a first DL SPS configuration corresponding to the first DL SPS transmission,
wherein multiple DL SPS transmissions correspond to the multiple DL SPS configurations,
wherein whether at least one of the multiple DL SPS transmissions shall carry multiple codewords is configured independently of whether another of the multiple DL SPS transmissions shall carry multiple codewords.

11. The method of claim 2, wherein the first DL SPS transmission is configured with multiple codewords,
wherein when the first DL SPS transmission is activated by a DCI message of a first format, one or more of the multiple codewords is enabled.

12. The method of claim 2, wherein the first DL SPS transmission is configured with multiple codewords,
wherein when the first DL SPS transmission is activated by a DCI message of a second format, only one of the multiple codewords is enabled.

13. (canceled)

14. The method of claim 2, wherein the first DL SPS transmission is configured with multiple codewords, and the method further comprises:
transmitting, to the network node, a third message comprising one or more indicators for acknowledging or negatively acknowledging at least two of the multiple codewords.

15. The method of claim 14, wherein the step of transmitting, to the network node, the third message comprises:
transmitting, to the network node, the third message comprising one or more indicators for acknowledging or negatively acknowledging the multiple codewords.

16. (canceled)

17. (canceled)

18. The method of claim 1, wherein a HARQ-ACK bit of 1 indicates a successfully decoded codeword while a HARQ-ACK bit of 0 indicates an unsuccessfully decoded codeword,
wherein a bundled indicator acknowledges or negatively acknowledges two or more codewords by performing a logical AND operation on HARQ-ACK bits for the two or more codewords.

19. The method of claim 1, further comprising:
receiving, from the network node, a configuration indicating whether the indicators in the third message shall be bundled indicators or not.

20-40. (canceled)

41. The method of claim 1, further comprising:
transmitting, to the network node, a fifth message indicating whether DL transmission with multiple codewords and/or with more than 4 layers is supported by the UE or not.

42-48. (canceled)

49. A user equipment, comprising:
a processor;
a memory storing instructions which, when executed by the processor, cause the processor to:
receive, from a network node, a first message for scheduling UL or DL transmission with one or multiple codewords; and
perform, with the network node, the UL or DL transmission at least partially based on the first message.

50. A method at a network node for UL or DL transmission, the method comprising:
transmitting, to a UE, a first message for scheduling UL or DL transmission with one or multiple codewords; and
performing, with the UE, the UL or DL transmission at least partially based on the first message.

51-67. (canceled)

68. The method of claim 50, further comprising:
transmitting, to the UE, a configuration indicating whether the indicators in the third message shall be bundled indicators or not.

69-89. (canceled)

90. The method of claim 50, further comprising:
receiving, from the UE, a fifth message indicating whether DL transmission with multiple codewords and/or with more than 4 layers is supported by the UE or not.

91-101. (canceled)
